(19) United States
(12) Patent Application Publication
(10) Pub. No.: US 2016/0216626 A1
(43) Pub. Date: Jul. 28, 2016

(54) BRILLIANT TONER, ELECTROSTATIC IMAGE DEVELOPER, AND TONER CARTRIDGE

(71) Applicant: FUJI XEROX CO., LTD., Tokyo (JP)

(72) Inventors: Tetsuya TAGUCHI, Minamiashigara-shi (JP); Atsushi SUGITATE, Minamiashigara-shi (JP); Shinya SAKAMOTO, Minamiashigara-shi (JP); Satomi HARA, Minamiashigara-shi (JP)

(21) Appl. No.: 14/812,755

(22) Filed: Jul. 29, 2015

(30) Foreign Application Priority Data
Jan. 28, 2015 (JP) 2015-014718
Jan. 28, 2015 (JP) 2015-014719

(51) Int. Cl. G03G 9/00

(52) U.S. Cl. CPC G03G 9/0926; G03G 9/08755; G03G 9/0819

(57) ABSTRACT

There is provided a brilliant toner containing a toner particle containing a binder resin, and flat-shaped brilliant pigments, wherein the number of the brilliant pigment contained is from 3.5 to 15 and the plurality of brilliant pigments are oriented mutually in the same direction, and an electrostatic image developer containing the brilliant toner and a carrier, and a toner cartridge storing the brilliant toner, which is able to be attached to and detached from an image forming apparatus.

### CROSS-REFERENCE TO RELATED APPLICATIONS

This application is based on and claims priority under 35 USC 119 from Japanese Patent Application No. 2015-014718 filed on Jan. 28, 2015 and Japanese Patent Application No. 2015-014719 filed on Jan. 28, 2015.

### BACKGROUND

1. Field

The present invention relates to a brilliant toner, an electrostatic image developer, and a toner cartridge.

2. Description of the Related Art

Conventionally, for forming a brilliant image, a toner containing a brilliant pigment such as metal pigment is known.

### SUMMARY

[1] A brilliant toner containing a toner particle containing:

a binder resin, and

flat-shaped brilliant pigments,

wherein the number of the brilliant pigment contained is from 3.5 to 15 and the plurality of brilliant pigments are oriented mutually in the same direction.

### BRIEF DESCRIPTION OF DRAWINGS

FIG. 1 is a cross-sectional view schematically illustrating an example of the toner (toner particle) according to an exemplary embodiment of the present invention.

FIG. 2 is a schematic configuration diagram illustrating an example of the image forming apparatus according to an exemplary embodiment of the present invention.

FIG. 3 is a schematic configuration diagram illustrating an example of the process cartridge according to an exemplary embodiment of the present invention.

FIG. 4A and FIG. 4B are schematic views for explaining an estimated action of the toner according to an exemplary embodiment of the present invention.

FIG. 5 is a photograph showing a cross-section of the toner (toner particle) produced in Example 1.

FIG. 6A and FIG. 6B are schematic views for explaining an estimated action of a conventional toner.

FIG. 7A and FIG. 7B are schematic views for explaining an estimated action of a conventional toner.

FIG. 8 is a photograph showing a cross-section of the toner (toner particle) produced in Comparative Example 1.

FIG. 9 is a photograph showing a cross-section of the toner (toner particle) produced in Comparative Example 2.

FIG. 10A, FIG. 10B, and FIG. 10C are schematic views for explaining an estimated action of the toner according to an exemplary embodiment of the present invention.

FIG. 11A, FIG. 11B, and FIG. 11C are schematic views for explaining an estimated action of a conventional toner.

### DESCRIPTION OF REFERENCE NUMERALS AND SIGNS

2: Toner particle
4: Brilliant pigment
20, 107: Photoreceptor (one example of the image holding member)
21: Charging device (one example of the charging unit)
22, 109: Exposure device (one example of the electrostatic image forming unit)
24, 112: Transfer device (one example of the transfer unit)
25: Cleaning device (one example of the cleaning unit)
28, 300: Recording paper (recording medium)
30, 111: Developing device (one example of the developing unit)
31: Developing vessel
32: Opening for development
33: Developing roll
34: Charge injection roll
36, 115: Fixing device (one example of the fixing unit)
40: Toner
108: Charging roll (one example of the charging unit)
113: Photoreceptor cleaning device (one example of the cleaning unit)
116: Mounting rail
117: Housing
118: Opening for exposure
200: Process cartridge

### DETAILED DESCRIPTION

Exemplary embodiments as an example of the brilliant toner, electrostatic image developer, and toner cartridge of the present invention are described in detail below.

### [Brilliant Toner]

The brilliant toner (hereinafter, sometimes referred to as “toner”) according to an exemplary embodiment of the present invention includes a toner particle containing a binder resin and a plurality of, 3.5 or more, flat-shaped brilliant pigments (hereinafter, sometimes simply referred to as “brilliant pigment”).

Thanks to the configuration above, the toner according to an exemplary embodiment of the present invention ensures that when a brilliant image is formed on a recording medium colored with a color except for white and black, the brilliant image is kept from taking on a color tinge of the recording medium while suppressing reduction in the brilliance of the brilliant image. The reason therefor is not clearly known but is presumed as follows.

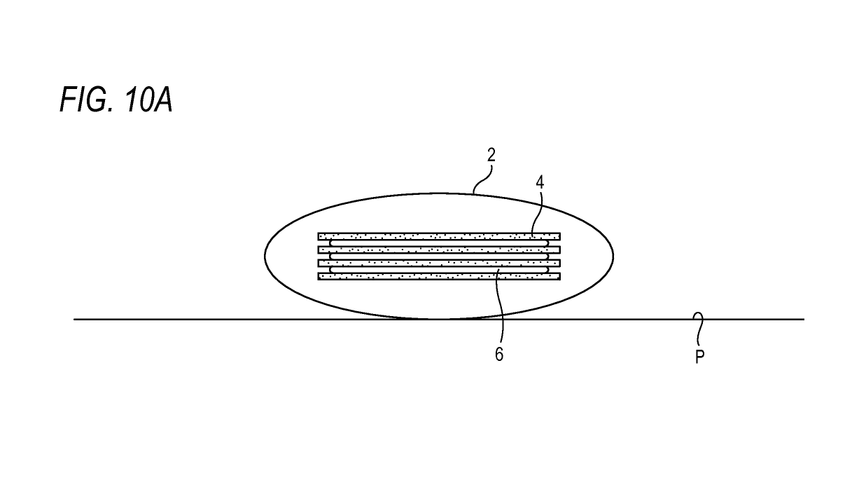

The toner particle containing a brilliant pigment is readily flat-shaped and is likely to lie on a recording medium in the oriented state (see, FIG. 6A). However, when fixed in this state, a gap produced between end parts of brilliant pigments remains as it is in a brilliant image formed, giving rise to low masking effect on the recording medium (FIG. 6B). Accordingly, a part of light incident on the image is likely to reach the underlying recording medium through the gap between brilliant pigments. In the case where the underlying recording medium is white, the reflected light from the recording medium is colorless. In the case where the underlying recording medium is black, since the recording medium absorbs light, the amount of reflected light from the recording medium is small and in turn, the color of the brilliant image is less affected by the color of the recording medium.

On the other hand, in the case where a brilliant image is formed on a recording medium colored with a color except for white or black, the obtained brilliant image readily takes on a color tinge of the recording medium. In other words, due to the effect of reflected light reflected from the colored recording medium except for white or black, the color of the recording medium is likely to be mixed in the brilliant image.

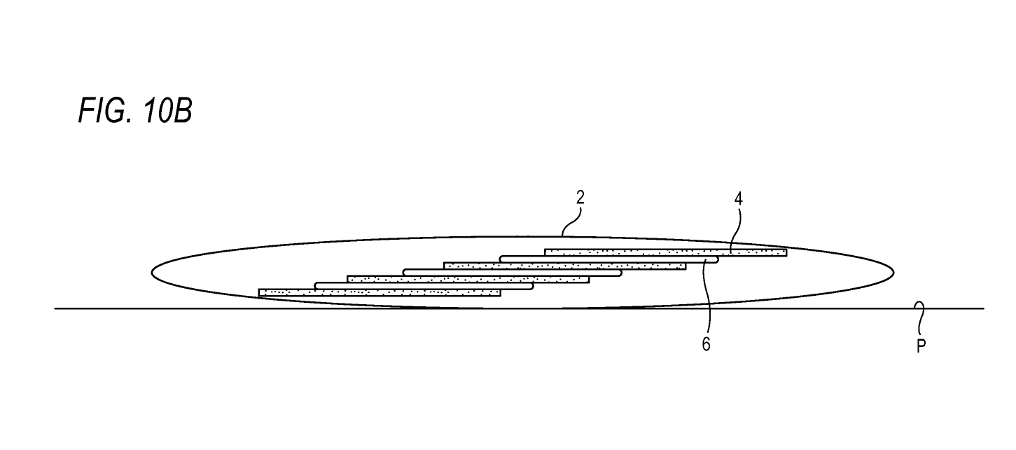

Meanwhile, when the toner loading amount is excessively increased, toner particles are overlapped and the masking effect on the recording medium may be increased, but orientation of toner particles is hardly permitted (FIG. 7A). When fixed in this state, overlapping of brilliant pigments with each other is generated to increase the masking effect and in turn, the brilliant image is less affected by the color of the recording medium, but the orientation property of the brilliant pigment is deteriorated (FIG. 7B). Accordingly, irregular reflection is caused by the brilliant pigment and regularly reflected light decreases, as a result, the brilliant image formed is readily reduced in the brilliance.

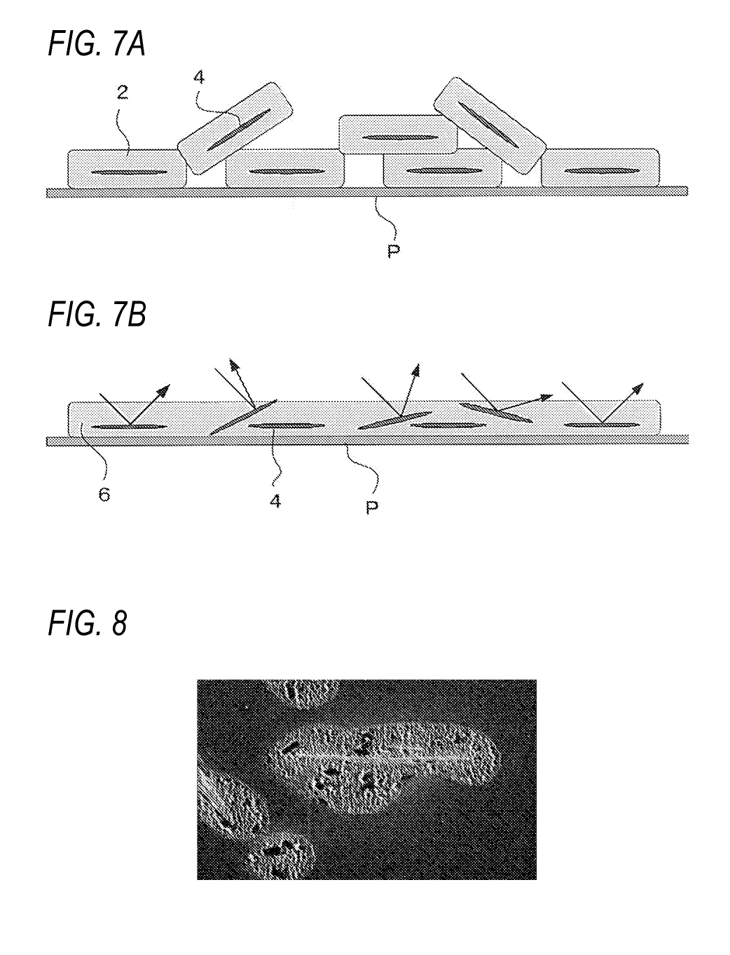

On the contrary, a toner particle containing a plurality of, 3.5 or more, brilliant pigments lies on a recording medium in the oriented state (see, FIG. 4A) and when fixed in this state, mutual brilliant pigments are likely to slide and expand in a direction along the recording medium while holding the orientation (see, FIG. 4B). In other words, the area where the recording medium is covered by the brilliant pigment, per one toner particle, is increased. Therefore, the masking effect by the brilliant pigment is enhanced even without excessively increasing the toner loading amount, and the brilliant image formed hardly takes on a color tinge of the underlying recording medium.

For these reasons, the toner according to an exemplary embodiment of the present invention is presumed to ensure that when a brilliant image is formed on a recording medium colored with a color except for white and black, the brilliant image is kept from taking on a color tinge of the recording medium while suppressing reduction in the brilliance of the brilliant image.

In FIG. 4A, FIG. 4B, FIG. 6A, FIG. 6B, FIG. 7A, and FIG. 7B, 2 indicates a toner particle, 4 indicates a brilliant pigment, 6 indicates a brilliant image (fixed image), and P indicates a recording medium.

In particular, for example, even when the toner loading amount on a recording medium is not excessively increased, the toner according to an exemplary embodiment of the present invention prevents, with a normal toner loading amount (for example, from 2.5 g/m² to 6.0 g/m²), a brilliant image from taking on a color tinge of the image forming surface while suppressing reduction in the brilliance of the brilliant image.

In addition, since the masking effect of the brilliant pigment inside the brilliant image is likely to decrease, for example, on plain paper having no coating layer (uncoated paper) or embossed paper having large surface unevenness, the brilliant image obtained is susceptible to the effect of underlying color, but the toner according to an embodiment of the present invention prevents a brilliant image from taking on a color tinge of the image forming surface while suppressing reduction in the brilliance of the brilliant image, compared with other toners.

The “brilliance” as used in the toner according to an exemplary embodiment of the present invention indicates that when an image formed by a brilliant toner is viewed, the image has brightness like metallic luster.

Specifically, in the toner according to an exemplary embodiment of the present invention, at the time of formation of a solid image, the ratio (X/Y) between the reflectance X at a light-receiving angle of +30° and the reflectance Y at a light-receiving angle of −30°, which are measured when irradiating the image with incident light at an incident angle of −45° by means of a goniophotometer, is preferably from 2 to 100.

The brilliant toner preferably satisfies the following formula, at the time of formation of a solid image:

2≦X/Y≦100

X, Y have the same meaning as X, Y as above.

The ratio (X/Y) being 2 or more indicates that the amount of reflection on the side (plus-angle side) opposite the light-entering side is larger than the amount of reflection on the side (minus-angle side) where incident light enters, namely, the light entered is prevented from diffuse reflection. On the occurrence of diffuse reflection of reflecting the entered light in various directions, when the reflected light is confirmed with an eye, the color appears dull. Therefore, if the ratio (X/Y) is less than 2, on viewing the reflected light, the gloss cannot be confirmed and the brilliance may be poor.

On the other hand, if the ratio (X/Y) exceeds 100, the viewing angle at which reflected light is visible becomes too narrow and since a specular reflection light component is large, the color sometimes appears blackish depending on the looking angle. In addition, production of a toner having a ratio (X/Y) exceeding 100 is difficult.

The ratio (X/Y) is more preferably from 50 to 100, still more preferably from 60 to 90, yet still more preferably from 70 to 80.

### —Measurement of Ratio (X/Y) by Goniophotometer—

First, the incident angle and the light-receiving angle are described. In an exemplary embodiment of the present invention, the incident angle is set to −45° at the time of measurement by a goniophotometer, because the measurement sensitivity is high for images over a wide range of glossiness.

In addition, the light-receiving angle is set to −30° and +30°, because the measurement sensitivity is highest for evaluating an image having brilliant feeling and an image having no brilliant feeling.

Next, the method of measuring the ratio (X/Y) is described.

With respect to an image (brilliant image) to be measured, using a goniospectrocolorimeter GC5000L manufactured by Nippon Denshoku Industries Co., Ltd. as the goniophotometer, incident light at an incident angle of −45° is made incident on the image and the reflectance X at a light-receiving angle of +30° and the reflectance Y at a light-receiving angle of −30° are measured. Here, each of the reflectance X and the reflectance Y is measured with light having a wavelength of from 400 nm to 700 nm at intervals of 20 nm, and the average value of reflectance at respective wavelengths is employed. The ratio (X/Y) is calculated from these measurement results.

Incidentally, the ratio (X/Y) is a flop index value (FI value: Flop Index value) as an indicator indicating metallic luster, measured in conformity with ASTM E2194.

From the standpoint of satisfying the above-described ratio (X/Y), the toner according to an exemplary embodiment of the present invention preferably satisfies the following requirements (1) and (2).

(1) The average equivalent-circle diameter D of the toner particle is longer than the average maximum thickness C.

(2) At the time of observing the cross-section in a thickness direction of a toner particle, the ratio of a brilliant pigment where the angle between a long axis direction in the cross-section of the toner particle and a long axis direction of the brilliant pigment is from −30° to +30° is 60% or more relative to all brilliant pigments observed.

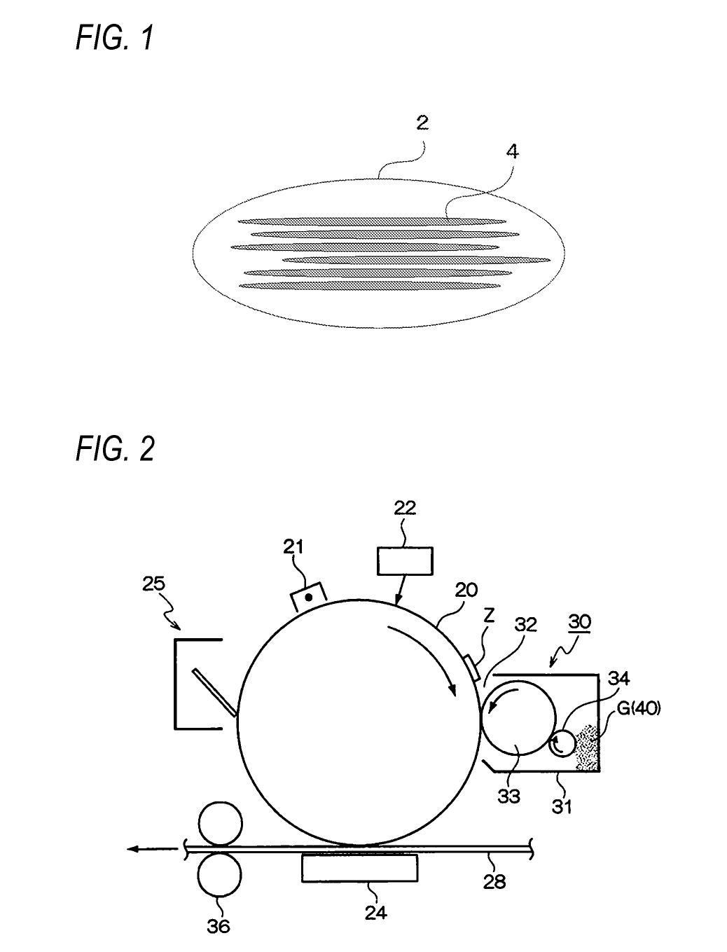

When the toner particle is flat-shaped with the equivalent-circle diameter being longer than the thickness (see, FIG. 1), in the fixing step for image formation, the pressure at the time of fixing is considered to align flat-shaped toner particles such that the flat surface side faces the recording medium surface.

For this reason, out of flat-shaped (flake-shaped) brilliant pigments contained in the toner particle, the brilliant pigment satisfying the requirement of (2) above, i.e., “the angle between a long axis direction in the cross-section of the toner and a long axis direction of the brilliant pigment is from −30° to +30°”, is considered to be aligned such that the surface side offering a maximum area faces the recording medium surface. It is believed that when the thus-formed image is irradiated with light, the ratio of a brilliant pigment causing diffuse reflection of incident light is reduced and in turn, the above-described range of the ratio (X/Y) is achieved.

Details of the toner according to an exemplary embodiment of the present invention are described below.

The toner according to an exemplary embodiment of the present invention contains a toner particle. The toner may have an external additive externally added to the toner particle.

The toner particle is described.

The toner particle contains, as shown in FIG. 1, for example, a binder resin and a plurality of, 3.5 or more, brilliant pigments. The toner particle may contain other additives such as release agent. In FIG. 1, 2 indicates a toner particle, and 4 indicates a brilliant pigment.

### —Binder Resin—

The binder resin includes, for example, a vinyl-based resin composed of a homopolymer of a monomer such as styrenes (e.g., styrene, p-chlorostyrene, α-methylstyrene), (meth)acrylic acid esters (e.g., methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate), ethylenically unsaturated nitriles (e.g., acrylonitrile, methacrylonitrile), vinyl ethers (e.g., vinyl methyl ether, vinyl isobutyl ether), vinyl ketones (e.g., vinyl methyl ketone, vinyl ethyl ketone, vinyl isopropenyl ketone) and olefins (e.g., ethylene, propylene, butadiene), or a copolymer using two or more of these monomers in combination.

The binder resin includes, for example, a non-vinyl-based resin such as epoxy resin, polyester resin, polyurethane resin, polyamide resin, cellulose resin, polyether resin and modified rosin, a mixture thereof with the above-described vinyl-based resin, and a graft polymer obtained by polymerizing a vinyl-based monomer in the presence of the resin above.

One of these binder resins may be used alone, or two or more thereof may be used in combination.

A polyester resin is suitable as the binder resin.

The polyester resin includes, for example, known polyester resins.

The polyester resin includes, for example, a condensation polymer of a polyvalent carboxylic acid and a polyhydric alcohol. As for the polyester resin, a commercially available product may be used, or a resin synthesized may be used.

The polyvalent carboxylic acid includes, for example, an aliphatic dicarboxylic acid (e.g., oxalic acid, malonic acid, maleic acid, fumaric acid, citraconic acid, itaconic acid, glutaconic acid, succinic acid, alkenyl succinic acid, adipic acid, sebacic acid), an alicyclic dicarboxylic acid (e.g., cyclohexanedicarboxylic acid), an aromatic dicarboxylic acid (e.g., terephthalic acid, isophthalic acid, phthalic acid, naphthalenedicarboxylic acid), an anhydride thereof, and a lower alkyl (for example, having a carbon number of 1 to 5) ester thereof. Among these, the polyvalent carboxylic acid is preferably, for example, an aromatic dicarboxylic acid.

As the polyvalent carboxylic acid, together with the dicarboxylic acid, a trivalent or higher valent carboxylic acid forming a crosslinked structure or a branched structure may be used in combination. The trivalent or higher valent carboxylic acid includes, for example, trimellitic acid, pyromellitic acid, an anhydride thereof, and a lower alkyl (for example, having a carbon number of 1 to 5) ester thereof.

One of these polyvalent carboxylic acids may be used alone, or two or more thereof may be used in combination.

The polyhydric alcohol includes, for example, an aliphatic diol (e.g., ethylene glycol, diethylene glycol, triethylene glycol, propylene glycol, butanediol, hexanediol, neopentyl glycol), an alicyclic diol (e.g., cyclohexanediol, cyclohexanedimethanol, hydrogenated bisphenol A), and an aromatic diol (e.g., an ethylene oxide adduct of bisphenol A, a propylene oxide adduct of bisphenol A). Among these, the polyhydric alcohol is preferably, for example, an aromatic diol or an alicyclic diol, more preferably an aromatic diol.

As the polyhydric alcohol, together with the diol, a trihydric or higher polyhydric alcohol forming a crosslinked structure or a branched structure may be used in combination. The trihydric or higher polyhydric alcohol includes, for example, glycerin, trimethylolpropane, and pentaerythritol.

One of these polyhydric alcohols may be used alone, or two or more thereof may be used in combination.

Moreover, the binder resin preferably contains an amorphous polyester resin.

As the amorphous polyester resin, for example, a condensation polymer of a polyvalent carboxylic acid and a polyhydric alcohol can be exemplified. As for the amorphous polyester resin, a commercially available product may be used, or a resin synthesized may be used.

The polyvalent carboxylic acid includes, for example, an aliphatic dicarboxylic acid (e.g., oxalic acid, malonic acid, maleic acid, fumaric acid, citraconic acid, itaconic acid, glutaconic acid, succinic acid, alkenyl succinic acid, adipic acid, sebacic acid), an alicyclic dicarboxylic acid (e.g., cyclohexanedicarboxylic acid), an aromatic dicarboxylic acid (e.g., terephthalic acid, isophthalic acid, phthalic acid, naphthalenedicarboxylic acid), an anhydride thereof, and a lower alkyl (for example, having a carbon number of 1 to 5) ester thereof. Among these, the polyvalent carboxylic acid is preferably, for example, an aromatic dicarboxylic acid.

As the polyvalent carboxylic acid, together with the dicarboxylic acid, a trivalent or higher valent carboxylic acid forming a crosslinked structure or a branched structure may be used in combination. The trivalent or higher valent carboxylic acid includes, for example, trimellitic acid, pyromellitic acid, an anhydride thereof, and a lower alkyl (for example, having a carbon number of 1 to 5) ester thereof.

One of these polyvalent carboxylic acids may be used alone, or two or more thereof may be used in combination.

The polyhydric alcohol includes, for example, an aliphatic diol (e.g., ethylene glycol, diethylene glycol, triethylene glycol, propylene glycol, butanediol, hexanediol, neopentyl glycol), an alicyclic diol (e.g., cyclohexanediol, cyclohexanedimethanol, hydrogenated bisphenol A), and an aromatic diol (e.g., an ethylene oxide adduct of bisphenol A, a propylene oxide adduct of bisphenol A). Among these, the polyhydric alcohol is preferably, for example, an aromatic diol or an alicyclic diol, more preferably an aromatic diol.

As the polyhydric alcohol, together with the diol, a trihydric or higher polyhydric alcohol forming a crosslinked structure or a branched structure may be used in combination. The trihydric or higher polyhydric alcohol includes, for example, glycerin, trimethylolpropane, and pentaerythritol.

One of these polyhydric alcohols may be used alone, or two or more thereof may be used in combination.

The glass transition temperature (Tg) of the amorphous polyester resin is preferably from 50° C. to 80° C., more preferably from 50° C. to 65° C.

The glass transition temperature is determined from a DSC curve obtained by differential scanning calorimetry (DSC), more specifically, from “Extrapolated Glass Transition Onset Temperature” described in the method for obtaining a glass transition temperature of JIS K-1987 “Measurement Method for Transition Temperature of Plastics”.

The weight average molecular weight (Mw) of the polyester resin is preferably from 5,000 to 1,000,000, more preferably from 7,000 to 500,000.

The number average molecular weight (Mn) of the polyester resin is preferably from 2,000 to 100,000.

The molecular weight distribution Mw/Mn of the polyester resin is preferably from 1.5 to 100, more preferably from 2 to 60.

The weigh average molecular weight and number average molecular weight are measured by gel permeation chromatography (GPC). The measurement of the molecular weight by GPC is performed with a THF solvent by using, as the measuring apparatus, GPC: HLC-8120GPC, manufactured by Tosoh Corporation and using a column, TSKGEL Super HM-M (15 cm), manufactured by Tosoh Corporation. The weight average molecular weight and number average molecular weight are calculated based on the measurement results by using a molecular weight calibration curve prepared from a monodisperse polystyrene standard sample.

The polyester resin is obtained by a known production method. Specifically, the polyester resin is obtained, for example, by a method where the polymerization temperature is set to be from 180° C. to 230° C. and after reducing, if desired, the pressure in the reaction system, the reaction is performed while removing water or alcohol occurring at the time of condensation.

Incidentally, in the case where a raw material monomer is insoluble or incompatible at the reaction temperature, the monomer may be dissolved by adding a high-boiling-point solvent as a dissolution aid. In this case, the polycondensation reaction is performed while removing the dissolution aid by distillation. In the copolymerization reaction, when a monomer with poor compatibility is present, the poorly compatible monomer may be previously condensed with an acid or alcohol to be polycondensed with the monomer, and then polycondensed together with the main component.

The content of the binder resin is, for example, preferably from 40 mass % to 95 mass %, more preferably from 50 mass % to 90 mass %, still more preferably from 60 mass % to 85 mass %, relative to the entire toner particle.

### —Brilliant Pigment—

The toner particle contains 3.5 or more brilliant pigments per one toner particle. From the standpoint of preventing a brilliant image from taking on a color tinge of the image-forming surface while suppressing reduction in the brilliance of the brilliant image, the number of brilliant pigments is preferably from 3.5 to 15, more preferably from 4 to 8.

If the number of brilliant pigments per one toner particle is small, it may be difficult to prevent a brilliant image from taking on a color tinge of the image-forming surface while suppressing reduction in the brilliance of the brilliant image. On the other hand, if the number of brilliant pigments per one toner particle is too large, the electrical characteristics of the toner particle may be deteriorated, giving rise to reduction in the image quality, such as image disturbance.

The number of brilliant pigments is a value measured by the following method.

A toner particle is embedded using a bisphenol A type liquid epoxy resin and a hardening agent and then, a cutting sample is prepared. Thereafter, the cutting sample is cut by means of a cutter using a diamond knife, for example, an ultramicrotome device (ULTRACUT UCT, manufactured by Leica), at −100° C. to prepare an observation sample. This observation sample is observed by an apparatus capable of TEM observation, for example, an ultrahigh resolution field-emission scanning electron microscope (S-4800, manufactured by Hitachi High-Technologies Corporation), at a magnification enough to observe approximately from 1 to 10 toner particles in one visual field. For making the pigment more visible, the accelerating voltage may be adjusted, or SEM observation may be performed instead of TEM observation.

Specifically, the cross-section of the toner particle (cross-section along a thickness direction of the toner particle) is observed, and the number of brilliant pigments contained in one toner particle is counted. This operation is performed on 100 toner particles, and the average value thereof is determined as the number of brilliant pigments contained in one toner particle.

A plurality of brilliant pigments are oriented mutually in the same direction in one toner particle. The configuration where a plurality of brilliant pigments are oriented mutually in the same direction indicates that long axis directions of a plurality of brilliant pigments are directed toward the same direction.

Specifically, the angle θ formed by mutual orientation directions of a plurality of brilliant pigments is preferably 20° or less, more preferably 15° or less, still more preferably 10° or less. The angle θ indicates an angle (acute angle) formed by virtual lines along long axial directions of mutual brilliant pigments. If this angle is large, the flatness of the toner particle is likely to be reduced, leading to deterioration in the orientation property of toner particles on a recording medium. In theory, the angle θ is preferably 0° or more.

The angle θ formed by mutual orientation directions of a plurality of brilliant pigments is a value measured by the following method.

The observation sample for measuring the number of toner particles is observed by TEM at a magnification enough to observe approximately from 1 to 5 toner particles in one visual field. Specifically, the cross-sections of the toner particle (cross-section along a thickness direction of the toner particle) is observed, and out of orientation directions (long axis directions) of a plurality of brilliant pigments contained in one toner particle, the angle formed by mutually adjoining brilliant pigments is determined on respective pairs. A maximum value thereof is obtained. This operation is performed on 100 toner particles, and the average value of maximum values is determined as the angle θ. Specifically, the angle θ is determined by measurement using an image analysis software, such as Image Analysis Software (WimROOF) produced by Mitani Corporation, or an output sample of the image observed and a protractor.

The resin or a crystalline substrate preferably intervenes in a gap between at least a pair of adjacent brilliant pigments out of a plurality of brilliant pigments. When the resin or a crystalline substrate intervenes in a gap between adjacent brilliant pigments, the resin intervening between brilliant pigments is softened at the time of fixing, as a result, adjacent brilliant pigments are likely to slide to each other and expand. In other words, the area in which the image forming surface is covered with a brilliant pigment is further increased per one toner particle. In turn, it is further facilitated to prevent a brilliant image from taking on a color tinge of the image forming surface while suppressing reduction in the brilliance of the brilliant image.

Incidentally, the resin or a crystalline substrate may be present in the entire gap between flat-shaped brilliant pigments or may be present in a part of the gap. The resin or a crystalline substrate may be present in a gap between at least a pair of adjacent brilliant pigments out of a plurality of brilliant pigments but is preferably present in the gap between all pairs of adjacent brilliant pigments.

In the description of the present invention, the “crystalline” means that the resin exhibits not a stepwise change in endothermic quantity but a definite endothermic peak, in the measurement by differential scanning calorimetry (DSC), and specifically indicates that the half-value width of the endothermic peak when measured at a temperature rise rate of 10 (° C./min) is within 10° C.

On the other hand, the “amorphous” indicates that the half-value width exceeds 10° C. and the resin exhibits a stepwise change in endothermic quantity or a definite endothermic peak is not observed.

The resin includes the resins recited as examples of the binder resin.

Whether the binder resin intervenes in a gap between brilliant pigments is confirmed by observing the observation sample for measuring the number of toner particles, by TEM at a magnification enough to observe approximate from 1 to 5 toner particles in one visual field.

Especially, when the crystalline substrate is used, reduction in the brilliance of a brilliant image is suppressed at the time of fixing under the conditions involving little deformation of a toner particle and thermal storability is assured. The reason therefor is not clearly known but is presumed as follows.

Recently, in association with recent power saving and high-speed output, it is required to perform fixing under the conditions where, for example, the nip pressure (a pressure applied to a recording medium by a fixing member at the time of fixing), the nip time (a time for which the pressure is applied to a recording medium by a fixing member at the time of fixing) and the fixing temperature are reduced. As one of the requirements, fixing is required to be performed at a low nip pressure, a short nip time and a low fixing temperature by means of a fixing unit of an electromagnetic induction heating system by increasing the process speed. The fixing conditions above are characterized in that an amorphous resin as a binder resin in a toner particle is less likely to undergo sufficient viscosity reduction (melting) and the fixing is performed in the state involving little deformation of a toner particle.

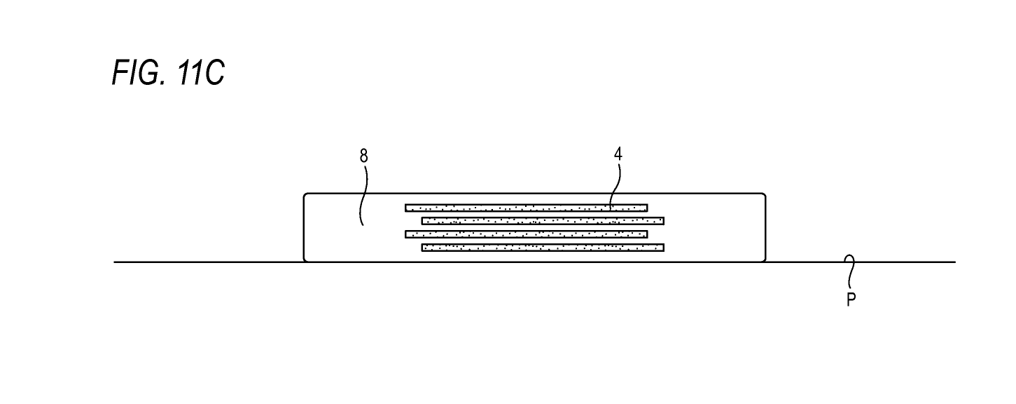

On the other hand, in the conventional toner particle containing a plurality of brilliant pigments, the plurality of brilliant pigments are in the state of being contacted and overlapped with each other (see, FIG. 11A).

However, when a toner particle in such a state is fixed under the conditions involving little deformation of the toner particle, an amorphous resin as a binder resin in the toner particle is less likely to undergo sufficient viscosity reduction (melting) as described above and since the pressure applied to the toner particle at the time of fixing is also low, the plurality of brilliant pigments can hardly slide to each other or overlapping of pigments with each other can be hardly eliminated (see, FIG. 11B). Then, the toner particle is fixed in a state close to such a state (see, FIG. 11C). That is, the plurality of brilliant pigments are fixed in the state of overlapping with each other and in the brilliant image formed, the coverage of a recording medium by the brilliant pigment is sometimes low, leading to reduction in the brilliance of the brilliant image.

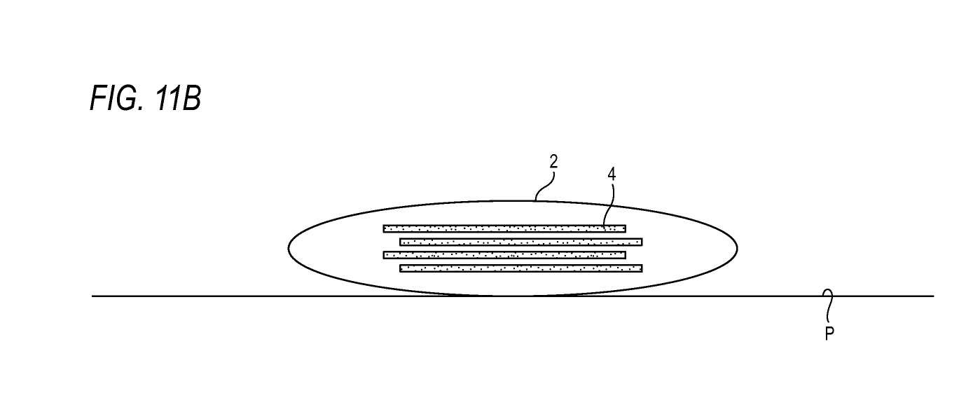

Meanwhile, in an exemplary embodiment of the present invention, in a toner particle containing a plurality of brilliant pigments, a crystalline substance intervenes in a gap between, out of the plurality of flat-shaped brilliant pigments, at least an adjacent pair of the plurality of flat-shaped brilliant pigments (see, FIG. 10A). In the case of a crystalline substance, unlike an amorphous resin, the crystalline substance undergoes sufficient viscosity reduction (melting) even when fixed under the conditions involving little deformation of the toner particle. Occurrence of viscosity reduction of the crystalline substance intervening in a gap between the plurality of flat-shaped brilliant pigment makes it easy for the plurality of flat-shaped brilliant pigments to slide to each other even when the pressure applied to the toner particle at the time of fixing is low (see, FIG. 10B), and after fixing is completed, the plurality of flat-shaped brilliant pigments expand to each other, as a result, in the brilliant image formed, the coverage of a recording medium by the brilliant pigment increases (see, FIG. 10C).

For these reasons, the toner according to an exemplary embodiment of the present invention is presumed to suppress reduction in the brilliance of a brilliant image when fixed under the conditions involving little deformation of a toner particle.

Reduction in the brilliance of a brilliant image at the time of fixing under the conditions involving little deformation of a toner particle can also be suppressed by lowering the glass transition temperature of the binder resin (amorphous resin), but in this case, thermal storability deteriorates. In contrast, in the toner according to an exemplary embodiment, even when the glass transition temperature of the binder resin (amorphous resin) is not lowered, reduction in the brilliance of a brilliant image is suppressed at the time of fixing under the conditions involving little deformation of a toner particle. Therefore, reduction in the brilliance of a brilliant image is suppressed while ensuring thermal stability.

In other words, the toner according to an exemplary embodiment of the present invention can satisfy both brilliance of a brilliant image and thermal storability of the toner.

Here, the conditions involving little deformation of a toner particle include, for example, the condition satisfying a nip pressure of from 1.0 kg/cm² to 2.0 kg/cm², a nip time of 40 milliseconds or less, and a fixing temperature of from 130° C. to 170° C. The fixing unit for performing fixing under the conditions involving little deformation of a toner particle includes a fixing unit of an electromagnetic induction heating system, etc.

In FIG. 10A, FIG. 10B, FIG. 10C, FIG. 11A, FIG. 11B, and FIG. 11C, 2 indicates a toner particle, 4 indicates a brilliant pigment, 6 indicates a crystalline substance, 8 indicates a brilliant image (fixed image), and P indicates a recording medium.

The brilliant pigment includes, for example, a pigment capable of imparting brilliant feeling like metallic luster (brilliant pigment). The brilliant pigment specifically includes, for example, a metal powder and an alloy powder, of aluminum (elemental Al metal), brass, bronze, nickel, stainless steel, zinc, etc.; mica coated with titanium oxide, yellow iron oxide, etc.; a coated thin inorganic crystal substrate such as barium sulfate, lamellar silicate and lamellar aluminum silicate; a single-crystal plate-like titanium oxide; a basic carbonate; an acid bismuth oxychloride; a natural guanine; a flaky glass powder; and a metal-deposited thin glass powder, and is not particularly limited as long as it has brilliance.

Among brilliant pigments, particularly in view of specular reflection intensity, a metal power is preferred, and aluminum is most preferred.

The shape of the brilliant pigment is a flat shape (flake shape).

The average length in a long axis direction of the brilliant pigments is preferably from 1 μm to 30 μm, more preferably from 3 μm to 20 μm, still more preferably from 5 μm to 15 μm.

Assuming that the average length in a thickness direction of the brilliant pigments is 1, the ratio of the average length in a long axis direction (aspect ratio) is preferably from 5 to 200, more preferably from 10 to 100, still more preferably from 30 to 70.

If the particle diameter of the brilliant pigment is too small, the brilliance tends to be deteriorated, whereas if the particle diameter of the brilliant pigment is too large, the strength of the toner particle obtained is likely to be decreased and the toner particle is readily deformed in an image forming apparatus.

In addition, if the aspect ratio of the brilliant pigment is too small, the brilliance tends to be deteriorated, whereas if the aspect ratio is too large, the strength of the toner particle obtained is likely to be decreased and the toner particle is readily deformed in an image forming apparatus.

The average length in a long axis direction and the aspect ratio of the brilliant pigments are measured by the following method. A photograph of pigment particles is taken by a scanning electron microscope (S-4100, manufactured by Hitachi High-Technologies Corporation) at a magnification enough to observe approximately from 5 to 20 pigment particles in an observation visual field, the length in a long axis direction and the length in a thickness direction of each particle are measured in a state of the obtained pigment particle image being two-dimensional processed, and the average length in a long axis direction and the aspect ratio of the brilliant pigment are calculated.

In order to facilitate observation of the pigment, a method of, for example, observing a pigment that is once charged into a surfactant solution, etc., then stirred, dispersed by ultrasonic treatment, etc., diluted, dropped on an observation stage of a microscope, and dried, may be employed.

The content of the brilliant pigment is, for example, preferably from 1 part by mass to 50 parts by mass, more preferably from 15 parts by mass to 25 parts by mass, per 100 parts by mass of the toner particles.

If the content of the brilliant pigment is too small, the brilliance of the image is likely to be reduced, whereas if the content of the brilliant pigment is too large, the electrical characteristics of the toner particle are readily deteriorated, giving rise to reduction in the image quality, such as image disturbance.

### —Crystalline Substrate—

A crystalline substrate preferably intervenes in a gap between at least an adjacent pair of a plurality of flat-shaped brilliant pigments. Specifically, the crystalline substrate intervenes in a gap between flat-shaped brilliant pigments, in a state of being phase-separated from the amorphous resin and forming a domain (region). The crystalline substrate may be present in the entire gap between flat-shaped brilliant pigments or may be present in a part of the gap. It may be sufficient if the crystalline substance is present in a gap between at least a pair of adjacent brilliant pigments out of a plurality of brilliant pigments, but the crystalline substrate is preferably present in a gap between all pairs of adjacent brilliant pigments.

Incidentally, the crystalline substance may also be present in a region other than a gap between a plurality of flat-shaped brilliant pigments.

Here, whether a crystalline substance intervenes in a gap between brilliant pigments is confirmed by the following method.

Specifically, a toner particle is embedded using a bisphenol A type liquid epoxy resin and a hardening agent and then, a cutting sample is prepared. Thereafter, the sample is sectioned by means of a cutter using a diamond knife, for example, ULTRACUT UCT (manufactured by Leica), at −100° C. The sectioned sample is dyed using an aqueous 0.5 wt % ruthenium tetroxide solution to prepare an observation sample, and the observation sample is observed by TEM at a magnification of around 5,000 times. A crystalline substance domain is determined by the contrast of color in the cross-section of the toner (cross-section along a thickness direction of the toner particle), and whether a crystalline substance intervenes in a gap between brilliant pigments is confirmed.

The crystalline substance includes a release agent, a crystalline resin, etc. Among these, from the standpoint of suppressing reduction in the brilliance of a brilliant image, the crystalline substance is preferably a release agent. The crystalline resin may be contained as a binder resin together with the amorphous resin in the toner particle.

### —Release Agent—

The release agent includes, for example, a hydrocarbon-based wax; a natural wax such as carnauba wax, rice wax and candelilla wax; a synthetic or mineral/petroleum-based wax such as montan wax; and an ester-based wax such as fatty acid ester and montanic acid ester. The release agent is not limited thereto.

Among these, the release agent is preferably a hydrocarbon-based wax. Since the hydrocarbon-based wax has low porality, brilliant pigments between which a crystalline substance intervenes are increased in the releasability from each other, and the brilliant pigments readily slide to each other at the time of fixing. As a result, reduction in the brilliance of a brilliant image is likely to be suppressed.

The hydrocarbon-based wax is a wax having a structure composed of hydrocarbon and includes, for example, Fischer-Tropsh wax, a polyethylene-based wax (wax having a polyethylene structure), a polypropylene-based wax (wax having a polypropylene structure), a paraffin-based wax (wax having a paraffin structure), and microcrystalline wax. Among these, from the standpoint of suppressing reduction in the brilliance of a brilliant image, the hydrocarbon-based wax is preferably Fischer-Tropsh wax.

The melting temperature of the release agent is preferably from 50° C. to 110° C., more preferably from 60° C. to 100° C.

If the dissolution temperature of the release agent is too low, the toner tends to be reduced in the thermal storability and readily aggregate, whereas if the dissolution temperature of the release agent is too high, the fixability of a toner image is likely to be deteriorated.

The melting temperature is determined from a DSC curve obtained by differential scanning calorimetry (DSC) by referring to “Melting Peak Temperature” described in the method for determining the melting temperature of JIS K-1987 “Measurement Method for Transition Temperature of Plastics”.

The content of the release agent is, for example, preferably from 1 mass % to 20 mass %, more preferably from 5 mass % to 15 mass %, relative to the entire toner particle.

If the content of the release agent is too small, the fixability of the toner particle is likely to be deteriorated, whereas if the content is too large, the powder fluidity tends to be reduced.

The crystalline resin includes known crystalline resins such as crystalline polyester resin and crystalline vinyl resin (e.g., polyalkylene resin, long-chain alkyl (meth)acrylate resin). Among these, in view of suppression of reduction in the brilliance of a brilliant image and low-temperature fixability, the crystalline resin is preferably a crystalline polyester resin.

The crystalline polyester resin includes, for example, a polycondensate of a polyvalent carboxylic acid and a polyhydric alcohol. As for the crystalline polyester resin, a commercially available product may be used, or a resin synthesized may be used.

Here, the crystalline polyester resin is preferably a polycondensate using a polymerizable monomer having a linear aliphatic group rather than that using a polymerizable monomer having an aromatic group, because a crystal structure is easily formed.

The polyvalent carboxylic acid includes, for example, an aliphatic dicarboxylic acid (e.g., oxalic acid, succinic acid, glutaric acid, adipic acid, suberic acid, azelaic acid, sebacic acid, 1,9-nonane dicarboxylic acid, 1,10-decane dicarboxylic acid, 1,12-dodecanedicarboxylic acid, 1,14-tetradecanedicarboxylic acid, 1,18-octadecanedicarboxylic acid), an aromatic dicarboxylic acid (e.g., a dibasic acid such as phthalic acid, isophthalic acid, terephthalic acid and naphthalene-2,6-dicarboxylic acid), an anhydride thereof, and a lower alkyl (for example, having a carbon number of 1 to 5) ester thereof.

As the polyvalent carboxylic acid, together with the dicarboxylic acid, a trivalent or higher valent carboxylic acid forming a crosslinked structure or a branched structure may be used in combination. The trivalent carboxylic acid includes, for example, an aromatic carboxylic acid (e.g., 1,2,3-benzenetricarboxylic acid, 1,2,4-benzenetricarboxylic acid and 1,2,4-naphthalenetricarboxylic acid), an anhydride thereof, and a lower alkyl (for example, having a carbon number of 1 to 5) ester thereof.

As the polyvalent carboxylic acid, together with such a dicarboxylic acid, a sulfonic acid group-containing dicarboxylic acid or an ethylenic double bond-containing dicarboxylic acid may be used in combination.

As for the polyvalent carboxylic acid, one polyvalent carboxylic acid may be used alone, or two or more polycarboxylic acids may be used in combination.

The polyhydric alcohol includes, for example, an aliphatic diol (for example, a linear aliphatic diol with the main chain moiety having a carbon number of 7 to 20). The aliphatic diol includes, for example, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these aliphatic diols, 1,8-octanediol, 1,9-nonanediol and 1,10-decanediol are preferred.

As the polyhydric alcohol, together with the dial, a trihydric or higher alcohol forming a crosslinked structure or a branched structure may be used in combination. The trihydric or higher alcohol includes, for example, glycerin, trimethylolethane, trimethylolpropane, and pentaerythritol.

As for the polyhydric alcohol, one polyhydric alcohol may be used alone, or two or more polyhydric alcohols may be used in combination.

Here, the content of the aliphatic diol in the polyhydric alcohol is preferably 80 mol % or more, more preferably 90 mol % or more.

The melting temperature of the crystalline polyester resin is preferably from 50° C. to 100° C., more preferably from 55° C. to 90° C., still more preferably from 60° C. to 85° C.

Incidentally, the melting temperature is determined from a DSC curve obtained by differential scanning calorimetry (DSC) by referring to “Melting Peak Temperature” described in the method for determining the melting temperature of HS K7121-1987 “Measurement Method for Transition Temperature of Plastics”.

The weight average molecular weight (Mw) of the crystalline polyester resin is preferably from 6,000 to 35,000.

The crystalline polyester resin is obtained, for example, by a known production method, similarly to the amorphous polyester resin.

From the standpoint of more increasing releasability of brilliant pigments from each other to facilitate sliding of brilliant pigments to each other at the time of fixing and suppress reduction in the brilliance of a brilliant image, the amount of the crystalline substance intervening in a gap between adjacent flat-shaped brilliant pigments is suitably from 0.3 μm² to 3.0 μm² (preferably from 0.5 μm² to 2.0 μm²).

The amount of the crystalline substance intervening in a gap between adjacent flat-shaped brilliant pigments is the amount of a crystalline substance present in one gap and is a value measured as follows. Specifically, a toner particle is embedded using a bisphenol A type liquid epoxy resin and a hardening agent and then, a cutting sample is prepared. Thereafter, the sample is sectioned by means of a cutter using a diamond knife, for example, ULTRACUT UCT (manufactured by Leica), at −100° C. The sectioned sample is dyed using an aqueous 0.5 wt % ruthenium tetroxide solution to prepare an observation sample, and the observation sample is observed by TEM at a magnification of around 5,000 times. A crystalline substance domain is determined by the contrast of color in the cross-section of the toner (cross-section along a thickness direction of the toner particle), the area of a crystalline substance domain intervening in a gap between brilliant pigments is measured on 100 toner particles, and the average value thereof is employed as the amount of the crystalline substance.

Out of the crystalline substance, the content of the release agent contained in the entire toner particle is preferably from 1 mass % to 20 mass %, more preferably from 5 mass % to 15 mass %, relative to the entire toner particle. The content of the crystalline resin contained in the entire toner particle is preferably from 2 mass % to 40 mass %, more preferably from 2 mass % to 20 mass %, relative to the entire binder resin, based on the entire toner particle.

### —Other Additives—

Other additives include, for example, known additives such as magnetic material, charge-controlling agent and inorganic powder. The toner particle contains such an additive as an internal additive.

—Characteristics, Etc. Of Toner Particle—

The toner particle may be a toner particle having a single-layer structure or may be a toner particle having a so-called core-shell structure consisting of a core part (core particle) and a coat layer (shell layer) covering the core part.

Here, the toner particle having a core-shell structure preferably consists of, for example, a core part configured to contain a binder resin, a brilliant pigment and, if desired, other additives such as release agent, and a coat layer configured to contain a binder resin.

Average Maximum Thickness C and Average Equivalent-Circle Diameter D of Toner Particles

As described in (1) above, the toner particle is flat-shaped, and its average equivalent-circle diameter D is preferably longer than the average maximum thickness C. The ratio (C/D) between the average maximum thickness C and the average equivalent-circle diameter D is preferably from 0.001 to 0.500, more preferably from 0.001 to 0.200, more preferably from 0.010 to 0.200, still more preferably from 0.050 to 0.100.

When the ratio (C/D) is 0.001 or more, the toner is assured of strength and prevented from breaking due to a stress at the time of image formation, and reduction in electrostatic charge stemming from exposure of the pigment and resultant occurrence of fogging are suppressed. On the other hand, when the ratio is 0.500 or less, excellent brilliance is obtained.

The average maximum thickness C and average equivalent-circle diameter D are measured by the following method.

Toner particles are placed on a smooth surface and evenly dispersed by applying vibration. With respect to 1,000 toner particles, the maximum thickness C and the equivalent-circle diameter D of a surface viewed from above, in a brilliant toner particle, are measured by a color laser microscope “VK-9700” (manufactured by Keyence Corporation) at a magnification of 1,000 times, and arithmetic averages thereof are determined, whereby the average maximum thickness and the average equivalent-circle diameter are calculated.

Angle Between a Long Axis Direction in the Cross-Section of Toner Particle and a Long Axis Direction of Brilliant Pigment Particle

As described in (2) above, at the time of observing the cross-section in a thickness direction of a toner particle, the ratio of a brilliant pigment particle (number basis) where the angle between a long axis direction in the cross-section of the toner particle and a long axis direction of the brilliant pigment particle is from −30° to +30° is preferably 60% or more relative to all brilliant pigment particles observed. The ratio is more preferably from 70% to 95%, still more preferably from 80% to 90%.

When the ratio above is 60% or more, excellent brilliance is obtained.

The method for observing the cross-section of a toner particle is described below.

A toner particle is embedded using a bisphenol A type liquid epoxy resin and a hardening agent and then, a cutting sample is prepared. Thereafter, the cutting sample is cut by means of a cutter using a diamond knife, for example, an ultramicrotome device (ULTRACUT UCT, manufactured by Leica), at −100° C. to prepare an observation sample. This observation sample is observed by an apparatus capable of TEM observation, for example, an ultrahigh resolution field-emission scanning electron microscope (S-4800, manufactured by Hitachi High-Technologies Corporation), at a magnification enough to observe approximately from 1 to 10 toner particles in one visual field.

Specifically, the cross-section of the toner particle (cross-section along a thickness direction of the toner particle) is observed; with respect to 100 toner particles observed, the number of brilliant pigment particles in which the angle between a long axis direction in the cross-section of the toner particle and a long axis direction of the brilliant pigment particle is from −30° to +30°, is counted using, for example, an image analysis software, such as Image Analysis Software (WimROOF) produced by Mitani Corporation, or an output sample of observed image and a protractor; and the ratio thereof is calculated.

Here, the “long axis direction in the cross-section of the toner particle” indicates a direction orthogonal to a thickness direction in the above-described toner particle in which the average equivalent-circle diameter D is longer than the average maximum thickness C, and the “long axis direction of the brilliant pigment particle” indicates a length direction of the brilliant pigment particle.

The volume average particle diameter of the toner particles is preferably from 1 μm to 30 μm, more preferably from 3 μm to 30 μm, further more preferably from 3 μm to 20 μm.

The volume average particle diameter D₅₀ᵥ of the toner particle is determined by drawing cumulative distributions for the volume and the number from the small diameter side with respect to particle size ranges (channels) divided based on the particle size distribution measured by a measuring instrument such as MULTISIZER II (manufactured by Beckman Coulter Inc.). The particle diameter at 16% accumulation is defined as volume D₁₆ᵥ and number D₁₆ₚ, the particle diameter at 50% accumulation is defined as volume D₅₀ᵥ and number D₅₀ₚ, and the particle diameter at 84% accumulation is defined as volume D₈₄ᵥ and number D₈₄ₚ. Using these, the volume average particle size distribution index (GSDv) is calculated as (D₈₄/D₁₆ᵥ)^{1/2}

### (External Additive)

The external additive includes, for example, an inorganic particle. The inorganic particle includes SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, MgSO₄, etc.

The surface of the inorganic particle as an external additive is preferably subjected to a hydrophobization treatment. The hydrophobization treatment is performed, for example, by dipping the inorganic particle in a hydrophobizing agent. The hydrophobizing agent is not particularly limited but includes, for example, a silane-based coupling agent, silicone oil, a titanate-based coupling agent, and an aluminum-based coupling agent. One of these may be used alone, or two or more thereof may be used in combination.

The amount of the hydrophobizing agent is usually, for example, from 1 part by mass to 10 parts by mass per 100 parts by mass of the inorganic particle.

The external additive also includes, for example, a resin particle (a resin particle of polystyrene, polymethyl methacrylate (PMMA), melamine resin, etc.), and a cleaning activator (for example, a metal salt of a higher fatty acid, typified by zinc stearate, and a particle of a fluorine-based high-molecular polymer).

The externally added amount of the external additive is, for example, preferably from 0.01 mass % to 5 mass %, more preferably from 0.01 mass % to 2.0 mass %, relative to the toner particle.

### (Production Method of Toner)

The production method of the toner according to an exemplary embodiment of the present invention is described below.

The toner according to an exemplary embodiment of the present invention is obtained, for example, by producing a toner particle and thereafter, externally adding an external additive to the toner particle.

The production method of the toner particle is not particularly limited, and the toner particle is produced, for example, by a known dry method such as kneading/pulverization method, or a known wet method such as emulsion aggregation method, dissolution suspension method and suspension polymerization method.

From the standpoint of incorporating a plurality of, 3.5 or more, flat-shaped brilliant pigments in the state of being oriented mutually in the same direction into the toner particle, an emulsion aggregation method is preferred, among others.

The emulsion aggregation method includes an emulsification step of forming a resin particle, etc. by emulsifying raw materials constituting the toner particle, an aggregation step of forming an aggregate of resin particles, and a coalescing step of fusing the aggregates.

The emulsion aggregation method includes an emulsification step of forming a resin particle, etc. by emulsifying raw materials constituting the toner particle, an aggregation step of forming an aggregate of the resin particle and a brilliant pigment, and a coalescing step of fusing the aggregates.

### —Emulsification Step—

For the production of a resin particle dispersion, in addition to production of a resin particle dispersion by a general polymerization method using, for example, an emulsion polymerization method, a suspension polymerization method, a dispersion polymerization method, etc., the emulsification may be performed by applying, by means of a dispersing machine, a shear force to a solution obtained by mixing an aqueous medium and a binder resin. At this time, a particle may be formed by heating the solution and thereby decreasing the viscosity of the resin component. In addition, a dispersant may also be used so as to stabilize the dispersed resin particles. Furthermore, when the resin dissolves in an oil-based solvent having a relatively low solubility in water, the resin particle dispersion is produced by dissolving the resin in such a solvent to generate particle dispersion together with a dispersant and a polymer electrolyte in water and thereafter evaporating off the solvent by heating or pressure reduction.

The aqueous medium includes, for example, water such as distilled water and ion-exchanged water, and alcohols, and is preferably water.

The dispersant used in the emulsification step includes, for example, a water-soluble polymer such as polyvinyl alcohol, methyl cellulose, ethyl cellulose, hydroxyethyl cellulose, carboxymethyl cellulose, sodium polyacrylate and sodium polymethacrylate; a surfactant, e.g., an anionic surfactant such as sodium dodecylbenzenesulfonate, sodium octadecylsulfate, sodium oleate, sodium laurate and potassium stearate, a cationic surfactant such as laurylamine acetate, stearylamine acetate and lauryltrimethylammonium chloride, a zwitterionic surfactant such as lauryl dimethylamine oxide, and a nonionic surfactant such as polyoxyethylene alkyl ether, polyoxyethylene alkylphenyl ether and polyoxyethylene alkylamine; and an inorganic salt such as tricalcium phosphate, aluminum hydroxide, calcium sulfate, calcium carbonate and barium carbonate.

The dispersing machine used for the production of an emulsion liquid includes, for example, a homogenizer, a homomixer, a pressure kneader, an extruder, and a media-assisted dispersing machine. The size of the resin particle is, in terms of the average particle diameter (volume average particle diameter), preferably 1.0 μm or less, more preferably from 60 urn to 300 nm, still more preferably from 150 nm to 250 nm. When the size is 60 nm or more, the resin particle is likely to become an unstable particle in the dispersion and therefore, aggregation of resin particles may be facilitated. In addition, when the size is 1.0 μm or less, the particle diameter distribution of the toner may be narrowed.

At the time of preparation of a release agent dispersion, a release agent is dispersed in water, together with an ionic surfactant or a polymer electrolyte such as polymer acid or polymer base, and the dispersion is then heated to a temperature not lower than the melting temperature of the release agent and at the same time, subjected to a dispersion treatment using a homogenizer or pressure discharge-type dispersing machine capable of imparting a strong shear force. Through such a treatment, a release agent dispersion is obtained. At the time of dispersion treatment, an inorganic compound such as polyaluminum chloride may be added to the dispersion. Preferable inorganic compounds include, for example, polyaluminum chloride, aluminum sulfate, highly basic polyaluminum chloride (BAC), polyaluminum hydroxide, and aluminum chloride. Among these, polyaluminum chloride, aluminum sulfate, etc. are preferred.

Through the dispersion treatment, a release agent dispersion containing a release agent particle having a volume average particle diameter of 1 μm or less is obtained. The volume average particle diameter of the release agent particle is more preferably from 100 nm to 500 nm.

When the volume average particle diameter is 100 nm or more, the release agent component is in general easily incorporated into the toner, though this may be affected by the characteristics of the binder resin used. In addition, when the volume average particle diameter is 500 nm or less, the dispersion state of the release agent in the toner is good.

For the preparation of a brilliant pigment dispersion, a known dispersion method may be used and, for example, a general dispersion unit such as rotary shearing-type homogenizer, ball mill having media, sand mill, DYNO mill and ULTIMIZER may be employed, but the dispersion method is not limited thereto. The brilliant pigment is dispersed in water, together with an ionic surfactant or a polyelectrolyte such as polymer acid or polymer base. The volume average particle diameter of the dispersed brilliant pigment may be 20 μm or less but is preferably from 3 μm to 16 μm, because the brilliant pigment is successfully dispersed in the toner without impairing the aggregability.

In addition, a dispersion of a binder resin-coated brilliant pigment may also be prepared by dispersing/dissolving a brilliant pigment and a binder resin in a solvent, thereby mixing them, and dispersing the mixture in water through phase inversion emulsification or shear emulsification.

### —Aggregation Step—

The aggregation step includes the steps of (A) and (B) below.

Step of (A): A step of 1) heating a mixed dispersion of a first resin particle dispersion and a brilliant pigment dispersion at a temperature less than the glass transition temperature of the first resin particle to form a first aggregate of a first resin particle and a brilliant pigment in the mixed dispersion, and 2) heating a mixed dispersion of a first aggregate dispersion, a second resin particle dispersion and, if desired, other dispersions such as release agent dispersion, at a temperature less than the glass transition temperature of the second resin particle to form, in the mixed dispersion, a second aggregate aggregated such that a second resin particle and, if desired, a release agent, etc. are attached to the surface of a first aggregate.

The step of (A) may be a step of 1) forming a fused particle by forming a first aggregate and then heating the first aggregate at a temperature not lower than the glass transition temperature of the first resin particle to fuse first aggregates, and 2) heating a mixed dispersion of the fused particle dispersion, a second resin particle dispersion and, if desired, other dispersions such as release agent dispersion, at a temperature less than the glass transition temperature of the second resin particle to form, in the mixed dispersion, a second aggregate aggregated such that a second resin particle and a release agent, etc. are attached to the surface of a fused particle.

Step of (B): A step of 1) forming a first brilliant pigment aggregate in a brilliant pigment dispersion, and 2) heating a mixed dispersion of a first brilliant pigment aggregate dispersion, a resin particle dispersion and, if desired, other dispersions such as release agent dispersion, at a temperature less than the glass transition temperature of the resin particle to form, in the mixed dispersion, a second aggregate aggregated such that a resin particle and a release agent, etc. are attached to the surface of a brilliant pigment aggregate.

In the step of (B), at the time of preparation of a brilliant pigment dispersion, a brilliant pigment dispersion having dispersed therein a brilliant pigment in an aggregated state may also be used as the first brilliant pigment aggregate dispersion. For example, 1) a brilliant pigment dispersion prepared by using a previously aggregated brilliant pigment while taking care not to disaggregate the brilliant pigment aggregate, and 2) a brilliant pigment dispersion obtained by aggregating a brilliant pigment at the time of preparation of a dispersion of a brilliant pigment coated with the binder resin or a thermoplastic resin different from the binder resin by means of a coacervation method, an in-liquid drying method, a precipitation polymerization method, etc., and dispersing the aggregate of a brilliant pigment coated with the binder resin or a thermoplastic resin different from the binder resin, may be used.

Here, both steps of (A) and (B) may be a step of, after the formation of a second aggregate particle, further heating a mixed solution of a second aggregate particle dispersion and a resin particle dispersion at a temperature less than the glass transition temperature of the resin particle to form, in the mixed dispersion, a third aggregate aggregated such that a resin particle is further attached to the surface of a second aggregate. In this case, the release agent or the brilliant pigment is less likely to be exposed to the surface of a toner particle, which is preferred in view of chargeability and developability. At the time of mixing a second aggregate particle dispersion and a resin particle dispersion, these dispersions may be mixed after an aggregating agent is added to the second aggregate particle dispersion or the pH is adjusted.

In both steps of (A) and (B), the orientation property of the brilliant pigment in the toner particle obtained is controlled, for example, by stirring conditions of the mixed dispersion at the time of formation of a first aggregate particle. In addition, the number of primary particles of the brilliant pigment in the brilliant pigment aggregate can be controlled, for example, by adjusting the brilliant pigment concentration in the mixed dispersion and therefore, the number of brilliant pigments in the toner particle obtained is controlled.

Moreover, in order to control an amount of the crystalline substance intervening in a gap between brilliant pigments, the following method can be conducted.

A step of 1) heating a mixed dispersion of a crystalline substance particle dispersion and a brilliant pigment dispersion at a temperature less than the melting temperature of the crystalline substance to form a first aggregate of a crystalline substance particle and a brilliant pigment in the mixed dispersion, and 2) heating a mixed dispersion of a first aggregate dispersion and an amorphous resin particle dispersion at a temperature less than the glass transition temperature of the amorphous resin particle to form, in the mixed dispersion, a second aggregate aggregated such that an amorphous resin particle is attached to the surface of a first aggregate.

The above step may be a step of heating a mixed dispersion of a first aggregate dispersion, an amorphous resin particle dispersion and a crystalline substance particle dispersion at a temperature less than the glass transition temperature of the amorphous resin particle to form, in the mixed dispersion, a second aggregate aggregated such that an amorphous resin particle and a crystalline substance particle are attached to the surface of a first aggregate.

The above step may be a step of 1) forming a fused particle by forming a first aggregate and then heating the first aggregate at a temperature not lower than the melting temperature of the crystalline substance particle to fuse first aggregates, and 2) heating a mixed dispersion of the fused particle dispersion and a second resin particle dispersion at a temperature less than the glass transition temperature of the amorphous resin particle to form, in the mixed dispersion, a second aggregate aggregated such that an amorphous resin particle is attached to the surface of a fused particle.

The above step may be a step of, after the formation of a second aggregate particle, further heating a mixed solution of a second aggregate particle dispersion and an amorphous resin particle dispersion at a temperature less than the glass transition temperature of the amorphous resin particle to form, in the mixed dispersion, a third aggregate aggregated such that an amorphous resin particle is further attached to the surface of a second aggregate. In this case, the crystalline substance or the brilliant pigment is less likely to be exposed to the surface of a toner particle, which is preferred in view of chargeability and developability. At the time of mixing a second aggregate particle dispersion and an amorphous resin particle dispersion, these dispersions may be mixed after an aggregating agent is added to the second aggregate particle dispersion or the pH is adjusted.

In the above step, the orientation property of the brilliant pigment in the toner particle obtained is controlled, for example, by stirring conditions of the mixed dispersion at the time of formation of a first aggregate particle. In addition, the number of brilliant pigments in the toner particle obtained can be controlled, for example, by adjusting the brilliant pigment concentration in the mixed dispersion. Furthermore, the amount of the crystalline substance intervening in a gap between brilliant pigments is controlled, for example, by adjusting the crystalline substance concentration in the mixed dispersion.

Here, in the aggregation step, each aggregate particle is formed in many cases by adjusting the pH of the mixed solution to acidic under stirring. The ratio (CID) can be made to fall in the preferable range by the stirring conditions. More specifically, when the mixed solution is stirred at a high speed and heated during formation of an aggregate particle (particularly, a second aggregate particle), the ratio (C/D) can be made small, and when the mixed solution is stirred at a lower speed and heated at a lower temperature, the ratio (C/D) can be made large. The pH is preferably from 2 to 7, and in this case, use of an aggregating agent is also effective.

In the aggregation step, when the aggregating agent is added in parts a plurality of times together with various dispersions such as resin particle dispersion, uneven distribution of each component in the toner can be advantageously reduced. Because, aggregate particles in respective dispersions differ in electric charge and therefore, the aggregate particles are generally formed in different orders.

As the aggregating agent, a surfactant having polarity opposite the polarity of the surfactant used as the dispersant above, an inorganic metal salt, and a divalent or higher valent metal complex are suitably used. Among others, a metal complex is preferably used, because the amount of the surfactant used can be reduced and the charging characteristics are improved.

As the inorganic metal salt, in particular, an aluminum salt and a polymer thereof are preferred. In order to obtain a narrower particle size distribution, the valence of the inorganic metal salt is suitably divalent rather than monovalent, trivalent rather than divalent, or tetravalent rather than trivalent, and with the same valence, a polymer type, i.e., an inorganic metal salt polymer, is more suitable.

In an exemplary embodiment of the present invention, a polymer of a tetravalent inorganic metal salt containing aluminum is preferably used so as to obtain a narrow particle size distribution.

### —Coalescing Step—

In the coalescing step, the progress of aggregation is stopped by raising the pH of the suspension of aggregate particles to a range from 3 to 9 under stirring conditions based on the aggregation step above, and the aggregated particles are fused by heating at a temperature not lower than the glass transition temperature of the resin particle.

As for the heating time, the heating may be performed for a time long enough to cause coalescence and may be performed for approximately from 0.5 hour to 10 hours.

After the coalescence, cooling is performed to obtain a fused particle. In the cooling step, crystallization may be promoted by applying so-called slow cooling of decreasing the cooling rate near the glass transition temperature (glass transition temperature ±10° C.) of the resin.

The fused particle obtained by coalescence is formed into a toner particle through a solid-liquid separation step such as filtration, and, if desired, a washing step and a drying step.

The toner according to an exemplary embodiment of the present invention is produced, for example, by adding an external additive to the dry toner particle obtained and mixing them. Mixing is preferably performed with, for example, a V-blender, a HENSCHEL mixer or a LÖEDIGE mixer. Furthermore, if desired, coarse particles of the toner may be removed using a vibration sieving machine, a wind classifier, etc.

### <Electrostatic Image Developer>

The electrostatic image developer according to an exemplary embodiment of the present invention contains at least the toner according to an exemplary embodiment of the present invention.

The electrostatic image developer according to an exemplary embodiment of the present invention may be a single-component developer containing only the toner according to an exemplary embodiment of the present invention or may be a two-component developer obtained by mixing the toner with a carrier.

The carrier is not particularly limited and includes known carriers. The carrier includes, for example, a coated carrier in which the surface of a core material composed of a magnetic powder is coated with a coating resin; a magnetic powder dispersion-type carrier in which a magnetic powder is dispersed/blended in a matrix resin; and a resin impregnation-type carrier in which a porous magnetic powder is impregnated with a resin.

Incidentally, the magnetic powder dispersion-type carrier and the resin impregnation-type carrier may be a carrier in which a constituent particle of the carrier serves as a core material and the core material is coated with a coating resin.

The magnetic powder includes, for example, a magnetic metal such as iron, nickel and cobalt, and a magnetic oxide such as ferrite and magnetite.

The coating resin and matrix resin include, for example, polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, a straight silicone resin configured to contain an organosiloxane bond, a modified product thereof, a fluororesin, polyester, polycarbonate, a phenolic resin, and an epoxy resin.

The coating resin and matrix resin may contain other additives such as electrically conductive particle.

The electrically conductive particle includes particles of a metal such as gold, silver and copper, carbon black, titanium oxide, zinc oxide, tin oxide, barium sulfate, aluminum borate, and potassium titanate.

Here, the method for coating the surface of a core material with a coating resin includes, for example, a method of coating the surface with a coat layer-forming solution obtained by dissolving a coating resin and, if desired, various additives in an appropriate solvent. The solvent is not particularly limited and may be selected by taking into account the coating resin used, coating suitability, etc.

Specific methods for resin coating include, for example, a dipping method of dipping a core material in a coat layer-forming solution, a spraying method of spraying a coat layer-forming solution onto the surface of a core material, a fluid bed method of spraying a coat layer-forming solution in the state of a core material being floated by flowing air, and a kneader-coater method of mixing a core material of the carrier and a coat layer-forming solution in a kneader-coater and removing the solvent.

The mixing ratio (mass ratio) between toner and carrier in a two-component developer is preferably toner:carrier=from 1:100 to 30:100, more preferably from 3:100 to 20:100.

### <Image Forming Apparatus/Image Forming Method>

The image forming apparatus/image forming method according to an exemplary embodiment of the present invention are described below.

The image forming apparatus according to an exemplary embodiment of the present invention includes an image holding member, a charging unit for charging the surface of the image holding member, an electrostatic image forming unit for forming an electrostatic image on the charged surface of the image holding member, a developing unit for storing an electrostatic image developer and developing the electrostatic image formed on the surface of the image holding member with the electrostatic image developer to form a toner image, a transfer unit for transferring the toner image formed on the surface of the image holding member onto a surface of a recording medium, and a fixing unit for fixing the toner image transferred onto the surface of the recording medium. As the electrostatic image developer, the electrostatic image developer according to an exemplary embodiment of the present invention is applied.

In the image forming apparatus according to an exemplary embodiment of the present invention, an image forming method including a charging step of charging a surface of an image holding member, an electrostatic image forming step of forming an electrostatic image on the charged surface of the image holding member, a developing step of developing the electrostatic image formed on the surface of the image holding member with the electrostatic image developer according to an exemplary embodiment of the present invention to form a toner image, a transfer step of transferring the toner image formed on the surface of the image holding member onto the surface of a recording medium, and a fixing step of fixing the toner image transferred onto the surface of the recording medium (the image forming method according to an exemplary embodiment of the present invention), is performed.

As for the image forming apparatus according to an exemplary embodiment of the present invention, there is applied a known image forming apparatus such as a direct transfer-type apparatus where a toner image formed on a surface of an image holding member is transferred directly onto a recording medium; an intermediate transfer-type apparatus where a toner image foamed on a surface of an image holding member is primarily transferred onto a surface of an intermediate transfer material and the toner image transferred onto the surface of the intermediate transfer material is secondarily transferred onto a surface of a recording medium; an apparatus equipped with a cleaning unit for cleaning the surface of the image holding member after transfer of a toner image but before charging; and an apparatus equipped with a erasing unit for irradiating the surface of the image holding member after transfer of a toner image but before charging, with erasing light to remove electrostatic charge.

In the case of an intermediate transfer-type apparatus, the configuration applied to the transfer unit consists of, for example, an intermediate transfer material onto the surface of which a toner image is transferred, a primary transfer unit for primarily transferring a toner image formed on a surface of an image holding member onto a surface of the intermediate transfer material, and a secondary transfer unit for secondarily transferring the toner image transferred onto the surface of the intermediate transfer material, onto a surface of a recording medium.

In the image forming apparatus according to an exemplary embodiment of the present invention, for example, the portion containing the developing unit may be a cartridge structure (process cartridge) that is attached to and detached from the image forming apparatus. As the process cartridge, for example, a process cartridge housing the electrostatic image developer according to an exemplary embodiment of the present invention and having a developing unit is suitably used.

One example of the image forming apparatus according to an exemplary embodiment of the present invention is described below, but the image forming apparatus is not limited thereto. Incidentally, main parts shown in the figure are described, and description of others is omitted.

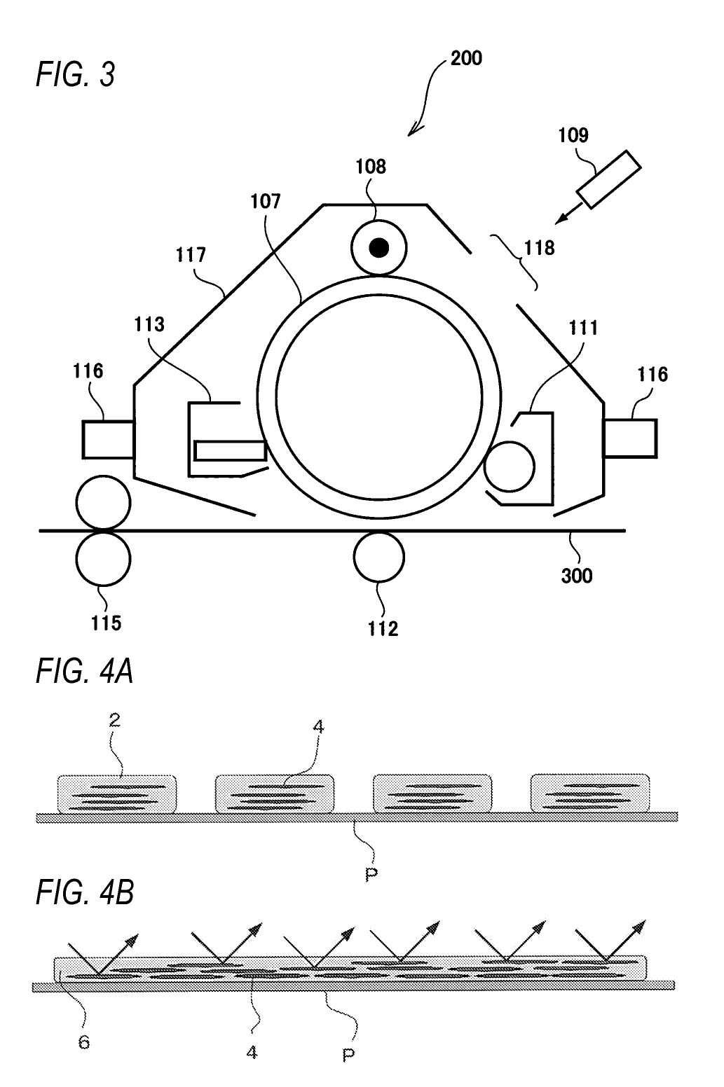

FIG. 2 is a schematic configuration diagram showing an example of the image forming apparatus according to an exemplary embodiment of the present invention including a developing device to which the electrostatic image developer according to an exemplary embodiment of the present invention is applied.

In the figure, the image forming apparatus according to an exemplary embodiment of the present invention has a photoreceptor 20 as the image holding member rotating in a fixed direction, and on the periphery of the photoreceptor 20, a charging device 21 (one example of the charging unit) for charging the photoreceptor 20 (one example of the image holding member), an electrostatic image forming device, for example, an exposure device 22 (one example of the electrostatic image forming unit), for forming an electrostatic image Z on the photoreceptor 20, a developing device 30 (one example of the developing unit) for visualizing the electrostatic image Z formed on the photoreceptor 20, a transfer device 24 (one example of the transfer unit) for transferring the toner image visualized on the photoreceptor 20 onto recording paper 28 as one example of the recording medium, and a cleaning device 25 (one example of the cleaning unit) for cleaning the residual toner on the photoreceptor 20 are sequentially arranged.

In an exemplary embodiment of the present invention, as illustrated in FIG. 2, the developing device 30 has a developing vessel 31 in which a developer G containing a toner 40 is stored, and in the developing vessel 31, an opening 32 for development is provided to face the photoreceptor 20, a developing roll (developing electrode) 33 as the toner holding member is provided to face toward the opening 32 for development, and a developing electric field is formed in a region (developing area) sandwiched between the photoreceptor 20 and the developing roll 33 by applying a fixed developing bias to the developing roll 33. Furthermore, in the developing vessel 31, a charge injection roll (an injection electrode) 34 as the charge injection member is provided to face the developing roll 33. In an exemplary embodiment of the present invention, particularly, the charge injection roll 34 is configured to serve also as a toner supply roll for supplying the toner 40 to the developing roll 33.

Here, the rotational direction of the charge injection roll 34 may be selected but considering the toner supply property and charge injection property, preferred is an embodiment where the charge injection roll 34 rotates in the same direction as the developing roll 33 with a peripheral velocity difference (for example, 1.5 times or more) at the part facing the developing roll and injects an electric charge while holding the toner 40 in the region sandwiched between the charge injection roll 34 and the developing roll 33 and rubbing the toner.

The operation of the image forming apparatus according to an exemplary embodiment is described below.

When an imaging process is started, first, the photoreceptor 20 surface is charged by the charging device 21, the exposure device 22 writes an electrostatic image Z on the charged photoreceptor 20, and the developing device 30 visualizes the electrostatic image Z to form a toner image. After that, the toner image on the photoreceptor 20 is conveyed to a transfer site, and the transfer device 24 electrostatically transfers the toner image on the photoreceptor 20 onto recording paper 28 as the recording medium. The residual toner on the photoreceptor 20 is cleaned off by the cleaning device 25. Thereafter, the toner image on the recording paper 28 is fixed by a fixing device 36 (one example of the fixing unit) to obtain an image.

### <Process Cartridge/Toner Cartridge>

The process cartridge according to an exemplary embodiment of the present invention is described.

The process cartridge according to an exemplary embodiment of the present invention is a process cartridge storing the electrostatic image developer according to an exemplary embodiment of the present invention, having a developing unit for developing an electrostatic image formed on a surface of an image holding member with the electrostatic image developer to form a toner image, and being attached to and detached from an image forming apparatus.

The process cartridge according to an exemplary embodiment of the present invention is not limited to the above-described configuration and may be configured to have a developing device and, if desired, additionally have, for example, at least one unit selected from other units such as image holding member, charging unit, electrostatic image forming unit and transfer unit.

One example of the process cartridge according to an exemplary embodiment of the present invention is described below, but the process cartridge is not limited thereto. Incidentally, main parts shown in the figure are described, and description of others is omitted.

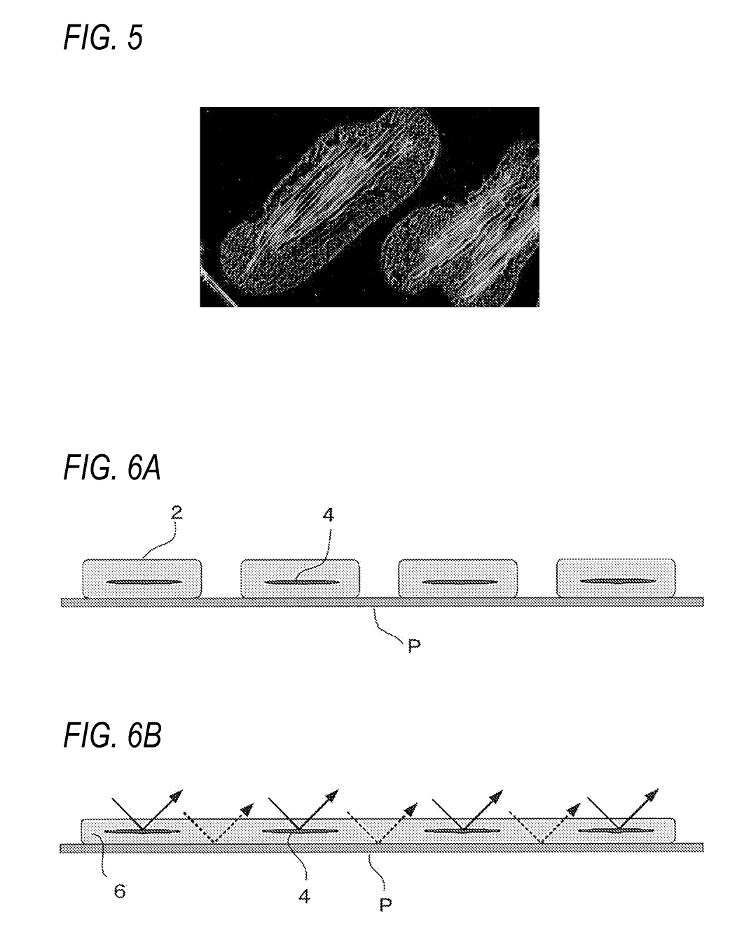

FIG. 3 is a schematic configuration diagram showing the process cartridge according to an exemplary embodiment of the present invention.

The process cartridge 200 shown in FIG. 3 has a configuration where, for example, a photoreceptor 107 (one example of the image holding member), a charging roll 108 (one example of the charging unit) provided on the periphery of the photoreceptor 107, a developing device 111 (one example of the developing unit), and a photoreceptor cleaning device 113 (one example of the cleaning unit) are held in an integrally combined manner by a mounting rail 116 and a housing 117 having an opening 118 for exposure and formed into a cartridge.

Incidentally, in FIG. 2, 109 is an exposure device (one example of the electrostatic image forming unit), 112 is a transfer device (one example of the transfer unit), 115 is a fixing device (one example of the fixing unit), and 300 is recording paper (one example of the recording medium).

The toner cartridge according to an exemplary embodiment of the present invention is described below. The toner cartridge according to an exemplary embodiment of the present invention may be configured to have a container to store the brilliant toner according to an exemplary embodiment of the present invention and be attached to and detached from an image forming apparatus. The toner cartridge according to an exemplary embodiment of the present invention may be sufficient if at least a toner is stored therein, and depending on the mechanism of the image forming apparatus, for example, a developer may be stored therein.

The image forming apparatus shown in FIG. 2 is an image forming apparatus configured to freely attach and detach a toner cartridge (not shown), and the developing device 30 is connected to the toner cartridge via a toner supply tube (not shown). In addition, when the toner stored in the toner cartridge runs low, the toner cartridge may be replaced.

### EXAMPLES

The exemplary embodiment of the present invention are described in detail below by referring to Examples, but the exemplary embodiment of the present invention is not limited to these Examples. In the following description, unless otherwise indicated, “parts” and “%” all are on the mass basis.

### <Preparation of Resin Particle Dispersion>

### (Preparation of Resin Particle Dispersion (1))

| | | |
|---|---|---|
| Dimethyl adipate | 74 | parts |
| Dimethyl terephthalate | 192 | parts |
| Bisphenol A ethylene oxide adduct | 216 | parts |
| Ethylene glycol | 38 | parts |
| Tetrabutoxy titanate (catalyst) | 0.037 | parts |

These components are put in a heated and dried two-necked flask and subjected to temperature elevation under stirring while keeping an inert atmosphere by introducing nitrogen gas into the vessel and then to a co-condensation polymerization reaction at 160° C. for 7 hours. Thereafter, the temperature is raised to 220° C. while gradually reducing the pressure to 10 Torr and held for 4 hours. The pressure is once returned to an ordinary pressure, and 9 parts of trimellitic anhydride is added. The pressure is again gradually reduced to 10 Torr, and the reaction solution is held at 220° C. for 1 hour to synthesize Binder Resin (1).

The glass transition temperature (Tg) of Binder Resin (1) is determined by measuring the resin in conformity with ASTM D3418-8 by using a differential scanning calorimeter (DSC-50 manufactured by Shimadzu Corporation) under the condition of a temperature rise rate of 10° C./min from room temperature (25° C.) to 150° C. The glass transition temperature is defined as a temperature at the intersection between extended lines of a base line and a rising line in an endothermic portion. The glass transition temperature of Binder Resin (1) is 63.5° C.

| | | |
|---|---|---|
| Binder Resin (1) | 165 | parts |
| Ethyl acetate | 240 | parts |
| Aqueous sodium hydroxide | 0.1 | parts |
| solution (0.3N) | | |

These components are put in a 1,000-ml separable flask, heated at 70° C. and stirred with Three-One Motor (manufactured by Shinto Scientific Co., Ltd.) to prepare a resin mixed solution. While further stirring the resin mixed solution at 90 rpm, 380 parts of ion-exchanged water is gradually added to cause phase inversion emulsification, and the solvent is then removed to obtain Resin Particle Dispersion (1) (solid content concentration: 30%). The volume average particle diameter of the resin particle in Resin Particle Dispersion (1) is 175 nm.

### <Preparation of Brilliant Pigment Dispersion>

### (Preparation of Brilliant Pigment Dispersion (1))

| | | |
|---|---|---|
| Aluminum pigment (2173EA, produced by Showa | 100 | parts |
| Alumi Company Limited) | | |
| Anionic surfactant (NEOGEN R, produced by DKS | 1.5 | parts |
| Co., Ltd.) | | |
| Ion-exchanged water | 900 | parts |

After removing the solvent from the paste of aluminum pigment, these components are mixed, dissolved, and dispersed for about 1 hour by using an emulsification dispersing machine CAVITRON (CR1010, manufactured by Pacific Machinery & Engineering Co., Ltd.) to prepare Brilliant Pigment Dispersion (1) having dispersed therein a brilliant pigment (aluminum pigment) (solid content concentration: 10%).

### (Preparation of Brilliant Pigment Dispersion (2))

| | | |
|---|---|---|
| Aluminum pigment (2173EA, produced by Showa | 100 | parts |
| Alumi Company Limited) | | |
| Polystyrene resin (molecular weight Mw: 20,000) | 1 | part |
| Methyl ethyl ketone (MEK) | 500 | parts |
| Ion-exchanged water | 900 | parts |
| Anionic surfactant (NEOGEN R, produced by DKS | 1.5 | parts |
| Co., Ltd.) | | |

After removing the solvent from the paste of aluminum pigment, the polystyrene resin is dissolved in MEK to obtain a polystyrene solution. The aluminum pigment from which the solvent is removed is added to the polystyrene solution, and keeping aware of evaporation of MEK, ultrasonic dispersion is performed for 30 minutes to obtain a polystyrene/aluminum mixed solution.

On the other hand, the anionic surfactant is dissolved in ion-exchanged water to obtain an aqueous anionic surfactant solution. The polystyrene/aluminum mixed solution is added dropwise to the aqueous anionic surfactant solution and mixed, and the resulting mixed solution is then dispersed for 10 minutes by using a homogenizer (ULTRA-TURRAX T50, manufactured by IKA) to obtain a polystyrene/aluminum dispersion.

This polystyrene/aluminum dispersion is transferred to a round-bottomed kettle with the lid being opened, and left to stand in a draft chamber for a whole day and night while continuing stirring to remove MEK. After confirming the removal of MEK, ion-exchanged water is added dropwise thereto for adjusting the solid content concentration to 10.1% to obtain Brilliant Pigment Dispersion (2).

### (Preparation of Brilliant Pigment Dispersion (3))

| | | |
|---|---|---|
| Aluminum pigment (2173EA, produced by Showa | 100 | parts |
| Alumi Company Limited) | | |
| Anionic surfactant (NEOGEN R, produced by DKS | 1.5 | parts |
| Co., Ltd.) | | |
| Ion-exchanged water | 900 | parts |
| Aluminum sulfate (produced by Asada Chemical | 1 | part |
| Industry Co., Ltd.) | | |

After removing the solvent from the paste of aluminum pigment, an aluminum sulfate solution is obtained by dissolving aluminum sulfate in ion-exchanged water. The aluminum pigment from which the solvent is removed is mixed with the aluminum sulfate solution, and the mixture is dispersed for about 5 minutes by using an emulsification dispersing machine CAVITRON (CR1010, manufactured by Pacific Machinery & Engineering Co., Ltd.) to obtain an aluminum pigment dispersion.

This aluminum dispersion is transferred to a round-bottomed kettle, subjected to temperature elevation to 65° C. under stirring, held for 30 minutes and after adding dropwise 10 parts of an aqueous 10% nitric acid solution, further held for 30 minutes. Thereafter, the aluminum dispersion is allowed to cool under stirring and when reached 30° C., the anionic surfactant is added dropwise. The solid content concentration of this aluminum dispersion is adjusted to 10% to obtain Brilliant Pigment Dispersion (3).

### (Preparation of Brilliant Pigment Dispersion (4))

| | | |
|---|---|---|
| Aluminum pigment (2173EA, produced by Showa | 100 | parts |
| Alumi Company Limited) | | |
| Anionic surfactant (NEOGEN R, produced by DKS | 1.5 | parts |
| Co., Ltd.) | | |
| Ion-exchanged water | 900 | parts |
| Aluminum sulfate (produced by Asada Chemical | 1 | part |
| Industry Co., Ltd.) | | |
| Resin Particle Dispersion (1) | 16.7 | parts |

After removing the solvent from the paste of aluminum pigment, an aluminum sulfate solution is obtained by dissolving aluminum sulfate in ion-exchanged water. The aluminum pigment from which the solvent is removed is mixed with the aluminum sulfate solution, and Resin Particle Dispersion (1) added dropwise while dispersing the mixture by using an emulsification dispersing machine CAVITRON (CR1010, manufactured by Pacific Machinery & Engineering Co., Ltd.) to obtain a resin particle/aluminum pigment dispersion. This resin particle/aluminum dispersion is transferred to a round-bottomed kettle, subjected to temperature elevation to 80° C. under stirring, and held for 90 minutes. Thereafter, the resin particle/aluminum dispersion is allowed to cool under stirring and when reached 30° C., the anionic surfactant is added dropwise. The solid content concentration of this aluminum dispersion is adjusted to 10.5% to obtain Brilliant Pigment Dispersion (4).

### <Preparation of Release Agent Dispersion>

### (Preparation of Release Agent Dispersion (1))

| | | |
|---|---|---|
| Carnauba wax (RC-160, produced by Toa Kasei Co., | 50 | parts |
| Ltd.) | | |
| Anionic surfactant (NEOGEN RK, produced by DKS | 1.0 | parts |
| Co., Ltd.) | | |
| Ion-exchanged water | 200 | parts |

These are mixed, heated to 95° C., dispersed by a homogenizer (ULTRA-TURRAX T50, manufactured by IKA), and then subjected to a dispersion treatment for 360 minutes by using a Manton-Gaulin high-pressure homogenizer (manufactured by Gaulin, Inc.) to prepare Release Agent Dispersion (1) (solid content concentration: 20%) in which release agent particles having a volume average particle diameter of 0.23 μm are dispersed.

### Example 1

### (Production of Toner Particle (1))

| | | |
|---|---|---|
| Resin Particle Dispersion (1) | 6.7 | parts |
| Brilliant Pigment Dispersion (1) | 200 | parts |
| Nonionic surfactant (IGEPAL CA897) | 0.3 | parts |

The raw materials above are put in a 2-L cylindrical stainless steel vessel and dispersed/mixed for 10 minutes while applying a shear force thereto at 4,000 rpm by means of a homogenizer (ULTRA-TURRAX T50, manufactured by IKA). Subsequently, 0.5 parts of an aqueous 10% nitric acid solution of polyaluminum chloride (PAHO2S, produced by Asada Chemical Industry Co., Ltd.) as an aggregating agent is gradually added dropwise thereto, and the resulting mixture is dispersed/mixed for 15 minutes by setting the rotation speed of the homogenizer to 5,000 rpm to obtain a mixed dispersion.

Thereafter, the mixed dispersion is transferred to a vessel equipped with a thermometer and a stirring device using a stirring blade with four inclined paddles and started to be heated by a mantle heater at a stirring rotation speed to 810 rpm, and the growth of an aggregate particle is promoted at 54° C. At this time, the pH of the raw material dispersion is controlled to a range from 2.2 to 3.5 with 0.3 N nitric acid or an aqueous 1 N sodium hydroxide solution. The pH is maintained in the range above for about 2 hours to form a first aggregate particle.

Then, the temperature is raised to 56° C., and the particle diameter and shape of the first aggregate particle are regulated while checking the size and shape of the particle by means of an optical microscope and MULTISIZER II. The pH is elevated to 8.0 so as to fuse first aggregate particles and thereafter, the temperature is raised to 75° C. After confirming by an optical microscope that first aggregate particles are fused, the pH is lowered to 6.0 while keeping the temperature at 75° C., and after 1 hour, heating is stopped, followed by cooling at a temperature drop rate of 1.0° C./min.

In this way, a fused particle is obtained.

To the dispersion having dispersed therein fused particles, a mixed solution obtained by mixing 160 parts of Resin Particle Dispersion (1) and 50 parts of Release Agent Dispersion Liquid (1) and 1.25 parts of an aqueous 10% nitric acid solution of polyaluminum chloride as an aggregating agent are additionally added. The resulting solution is started to be heated by a mantle heater while adjusting the stirring rotation speed to keep the liquid level always moving, and the growth of the aggregate particle is promoted at 54° C. At this time, the pH of the raw material dispersion is controlled to a range from 2.2 to 3.5 with 0.3 N nitric acid or an aqueous 1 N sodium hydroxide solution. The pH is maintained in the range above for about 2 hours to form a second aggregate particle aggregated such that a resin particle and a release agent are attached to the surface of a fused particle.

Furthermore, 66.7 parts of Resin Particle Dispersion (1) is added to form a third aggregate particle aggregated such that a resin particle is attached to the surface of a second aggregate particle. Then, the temperature is raised to 56° C., and the aggregate particles are regulated while checking the size and morphology of the particle by means of an optical microscope and MULTISIZER II. The pH is elevated to 8.0 so as to fuse third aggregate particles and thereafter, the temperature is raised to 75° C. After confirming by an optical microscope that third aggregate particles are fused, the pH is lowered to 6.0 while keeping the temperature at 75° C. and after 1 hour, heating is stopped, followed by cooling at a temperature drop rate of 0.0° C./min. Thereafter, the particles are sieved through a 20 μm mesh, repeatedly washed with water and then dried in a vacuum drier to obtain Toner Particle (1). The volume average particle diameter of Toner Particle (1) obtained is 12.1 μm. In addition, it is confirmed that Toner Particle (1) is flat-shaped and the average equivalent-circle diameter D thereof is longer than the average maximum thickness C.

### (Production of Toner)

2.0 Parts of hydrophobic silica (RY50, produced by Nippon Aerosil Co., Ltd.) is mixed with 100 parts of Toner Particle (1) by using a HENSCHEL mixer at a peripheral velocity of 30 msec for 3 minutes. Thereafter, the mixture is sieved through a vibration sieve having a mesh size of 45 μm to prepare Toner (1).

### (Production of Carrier)

| | | |
|---|---|---|
| Ferrite particle (volume average particle diameter: 35 μm) | 100 | parts |
| Toluene | 14 | parts |
| Perfluoroacrylate copolymer (critical surface tension: | 1.6 | parts |
| 24 dyn/cm) | | |
| Carbon black (trade name: VXC-72, produced by | 0.12 | parts |
| Cabot Corporation, volume resistivity: 100 Ωcm or | | |
| less) | | |
| Crosslinked melamine resin particle (average particle | 0.3 | parts |
| diameter: 0.3 μm, insoluble in toluene) | | |

First, carbon black diluted with toluene is added to the perfluoroacrylate copolymer, and the resultant mixture is dispersed using a sand mill. Subsequently, respective components above except for the ferrite particle are dispersed therein for 10 minutes by using a stirrer to prepare a coat layer-forming solution. This coat layer-forming solution and the ferrite particle are put in a vacuum deaeration-type kneader and stirred for 30 minutes at a temperature of 60° C. Toluene is then removed by distillation under reduced pressure to form a resin coat layer, and a carrier is thereby obtained.

### (Production of Developer)

70 Parts of Toner (1) and 780 parts of the carrier obtained above are put in a 2-L V-blender, stirred for 20 minutes and thereafter, sieved with a mesh size of 212 μm to produce Developer (1).

### Example 2

Toner Particle (2) is produced as follows. Developer (2) is produced in the same manner as in Example 1 except for using Toner Particle (2).

### (Production of Toner Particle (2))

Toner Particle (2) is obtained in the same manner as Toner Particle (1) except that the stirring device using a stirring blade with four inclined paddles is replaced by a stirring device using a stirring blade with three sweepback wings.

### Example 3

Toner Particle (3) is produced as follows. Developer (3) is produced in the same manner as in Example 1 except for using Toner Particle (3).

### (Production of Toner Particle (3))

| | | |
|---|---|---|
| Resin Particle Dispersion (1) | 6.7 | parts |
| Brilliant Pigment Dispersion (1) | 200 | parts |
| Nonionic surfactant (IGEPAL CA897) | 0.3 | parts |

The raw materials above are put in a 2-L cylindrical stainless steel vessel and dispersed/mixed for 10 minutes while applying a shear force thereto at 2,000 rpm by means of a homogenizer (ULTRA-TURRAX T50, manufactured by IKA). Subsequently, 0.5 parts of an aqueous 10% nitric acid solution of polyaluminum chloride (PAHO2S, produced by Asada Chemical Industry Co., Ltd.) as an aggregating agent is gradually added dropwise thereto, and the resulting mixture is dispersed/mixed for 15 minutes by setting the rotation speed of the homogenizer to 5,000 rpm to obtain a mixed dispersion.

Thereafter, the mixed dispersion is transferred to a vessel equipped with a thermometer and a stirring device using a stirring blade with three sweepback wings and started to be heated with a mantle heater by setting the stirring rotation speed to 810 rpm, and the growth of an aggregate particle is promoted at 54° C. At this time, the pH of the raw material dispersion is controlled to a range from 2.2 to 3.5 with 0.3 N nitric acid or an aqueous 1 N sodium hydroxide solution. The pH is maintained in the range above for about 2 hours to form a first aggregate particle.

To the dispersion having dispersed therein first aggregate particles, a mixed solution obtained by mixing 160 parts of Resin Particle Dispersion (1) and 50 parts of Release Agent Dispersion (1) and 1.25 parts of an aqueous 10% nitric acid solution of polyaluminum chloride as an aggregating agent are additionally added. The resulting solution is started to be heated by a mantle heater while adjusting the stirring rotation speed to keep the liquid level always moving, and the growth of the aggregate particle is promoted at 54° C. At this time, the pH of the raw material dispersion is controlled to a range from 2.2 to 3.5 with 0.3 N nitric acid or an aqueous 1 N sodium hydroxide solution. The pH is maintained in the range above for about 2 hours to form a second aggregate particle aggregated such that a resin particle and a release agent are attached to the surface of a first aggregate particle.

Furthermore, 66.7 parts of Resin Particle Dispersion (1) is added to form a third aggregate particle aggregated such that a resin particle is attached to the surface of a second aggregate particle. Then, the temperature is raised to 56° C., and the aggregate particles are regulated while checking the size and morphology of the particle by means of an optical microscope and MULTISIZER II. The pH is elevated to 8.0 so as to fuse third aggregate particles and thereafter, the temperature is raised to 75° C. After confirming by an optical microscope that third aggregate particles are fused, the pH is lowered to 6.0 while keeping the temperature at 75° C. After 1 hour, heating is stopped, followed by cooling at a temperature drop rate of 1.0° C./min, and the particles are then sieved through a 20 μm mesh, repeatedly washed with water and dried in a vacuum drier to obtain Toner Particle (3). The volume average particle diameter of Toner Particle (3) obtained is 13.6 μm. In addition, it is confirmed that Toner Particle (3) is flat-shaped and the average equivalent-circle diameter D thereof is longer than the average maximum thickness C.

### Example 4

Toner Particle (4) is produced as follows. Developer (4) is produced in the same manner as in Example 1 except for using Toner Particle (4).

### (Production of Toner Particle (4))

Toner Particle (4) is obtained in the same manner as Toner Particle (3) except that the amount of Brilliant Pigment Dispersion (1) added is changed from 3.33 parts to 5.0 parts and the stirring device using a stirring blade with three sweepback wings is replaced by a stirring device using a stirring blade with a half-moon plate wing.

### Example 5

Toner Particle (5) is produced as follows. Developer (5) is produced in the same manner as in Example 1 except for using Toner Particle (5).

### (Production of Toner Particle (5))

Toner Particle (5) is obtained in the same manner as Toner Particle (3) except that the stirring device using a stirring blade with three sweepback wings is replaced by a stirring device using a stirring blade with an anchor wing.

### Example 6

Toner Particle (6) is produced as follows. Developer (6) is produced in the same manner as in Example 1 except for using Toner Particle (6).

### (Production of Toner Particle (6))

Toner Particle (6) is obtained in the same manner as Toner Particle (3) except that the stirring device using a stirring blade with three sweepback wings is replaced by a stirring device using a stirring blade with six turbine wings and a baffle plate is provided inside the vessel.

### Example 7

Toner Particle (7) is produced as follows. Developer (7) is produced in the same manner as in Example 1 except for using Toner Particle (7).

### (Production of Toner Particle (7))

Toner Particle (7) is obtained in the same manner as Toner Particle (3) except that Brilliant Pigment Dispersion (1) is replaced by Brilliant Pigment Dispersion (2).

### Example 8

Toner Particle (8) is produced as follows. Developer (8) is produced in the same manner as in Example 1 except for using Toner Particle (8).

### (Production of Toner Particle (8))

Toner Particle (8) is obtained in the same manner as Toner Particle (3) except that Brilliant Pigment Dispersion (1) is replaced by Brilliant Pigment Dispersion (3).

### Example 9

Toner Particle (9) is produced as follows. Developer (9) is produced in the same manner as in Example 1 except for using Toner Particle (9).

### (Production of Toner Particle (9))

Toner Particle (9) is obtained in the same manner as Toner Particle (1) except that Brilliant Pigment Dispersion (1) is replaced by Brilliant Pigment Dispersion (4).

### Example 10

Toner Particle (10) is produced as follows. Developer (10) is produced in the same manner as in Example 1 except for using Toner Particle (10).

### (Production of Toner Particle (10))

Brilliant Pigment Dispersion (3) is washed with water and then freeze-dried to obtain Pigment Powder (1).

Next, 100 parts of Binder Resin (1), 100 parts of Pigment Powder (1) and 50 parts of toluene are charged into a kneader as a kneading machine and mixed at 60° C. The obtained mixture is, before being solidified, unidirectionally drawn into a sheet shape with a thickness of about 5 mm, then transferred to a metal vat disposed in a draft chamber and after removing the solvent, crushed by means of a pin mill to obtain Pigment Mixed Resin (1).

Thereafter, 10 parts of carnauba wax (RC-160, produced by Toa Kasei Co., Ltd.), 50 parts of Binder Resin (1) and 40 parts of Pigment Mixed Resin (1) are premixed, then kneaded using a BANBURY mixer (90 rpm, ram pressure: 4 kgf), further rolled by a roller while unidirectionally drawing the mixture into a plate shape, and cooled. After the cooling, the cooled mixture is pulverized by means of 100 AFG (pulverization pressure: 0.4 MPa, pulverization nozzle diameter φ: 2 mm), and Toner Particle (10) having an average particle diameter of 13.5 μm is obtained using an elbow-jet classifier.

### Comparative Example 1

Comparative Toner Particle (C1) is produced as follows. A developer is produced in the same manner as in Example 1 except for using Comparative Toner Particle (C1).

### (Production of Comparative Toner Particle (C1))

| | | |
|---|---|---|
| Resin Particle Dispersion (1) | 183.3 | parts |
| Release Agent Dispersion (1) | 50 | parts |
| Brilliant Pigment Dispersion Liquid (1) | 200 | parts |
| Nonionic surfactant (IGEPAL CA897) | 1.40 | parts |

The raw materials above are put in a 2-L cylindrical stainless steel vessel and dispersed/mixed for 20 minutes while applying a shear force thereto at 4,000 rpm by means of a homogenizer (ULTRA-TURRAX T50, manufactured by IKA). Subsequently, 1.5 parts of an aqueous 10% nitric acid solution of polyaluminum chloride as an aggregating agent is gradually added dropwise thereto, and the resulting mixture is dispersed/mixed for 30 minutes by setting the rotation speed of the homogenizer to 6,000 rpm to make a raw material dispersion.

The raw material dispersion is then transferred to a vessel equipped with a thermometer and a stirring device using a stirring blade with an anchor wing and started to be heated by a mantle heater while adjusting the stirring rotation speed to keep the liquid level always moving, and the growth of an aggregate particle is promoted at 54° C. At this time, the pH of the raw material dispersion is controlled to a range from 2.2 to 3.5 with 0.3 N nitric acid or an aqueous 1 N sodium hydroxide solution. The pH is maintained in the range above for about 2 hours to form an aggregate particle.

Subsequently, 50 parts of the resin particle dispersion and 0.25 parts of an aqueous 10% nitric acid solution of polyaluminum chloride are additionally added, and a resin particle of the binder resin is thereby attached to the surface of the aggregate particle above. The temperature is further raised to 56° C., and the aggregate particles are regulated while checking the size and morphology of the particle by means of an optical microscope and MULTISIZER II. Thereafter, the pH is elevated to 8.0 so as to fuse aggregate particles, and the temperature is then raised to 75° C. After confirming by an optical microscope that third aggregate particles are fused, the pH is lowered to 6.0 while keeping the temperature at 75° C. After 1 hour, heating is stopped, followed by cooling at a temperature drop rate of 1.0° C./min, and the particles are sieved through a 20 μm mesh, repeatedly washed with water and dried in a vacuum drier to obtain a toner particle. The volume average particle diameter of the toner particle obtained is 10.3 μm. In addition, it is confirmed that Toner Particle (C1) is flat-shaped and the average equivalent-circle diameter D thereof is longer than the average maximum thickness C.

### Comparative Example 2

Comparative Toner Particle (C2) is produced as follows. A developer is produced in the same manner as in Example 1 except for using Comparative Toner Particle (C2).

### (Production of Comparative Toner Particle (C2))

| | | |
|---|---|---|
| Resin Particle Dispersion (1) | 166.7 | parts |
| Brilliant Pigment Dispersion (1) | 200 | parts |
| Release agent dispersion | 50 | parts |
| Nonionic surfactant (IGEPAL CA897) | 0.3 | parts |

The raw materials above are put in a 2-L cylindrical stainless steel vessel and dispersed/mixed for 10 minutes while applying a shear force thereto at 2,000 rpm by means of a homogenizer (ULTRA-TURRAX T50, manufactured by IKA). Subsequently, 1.5 parts of an aqueous 10% nitric acid solution of polyaluminum chloride (PAHO2S, produced by Asada Chemical Industry Co., Ltd.) as an aggregating agent is gradually added dropwise thereto, and the resulting mixture is dispersed/mixed for 15 minutes by setting the rotation speed of the homogenizer to 5,000 rpm to obtain a mixed dispersion.

Thereafter, the mixed dispersion is transferred to a vessel equipped with a thermometer and a stirring device using a stirring blade with four inclined paddles and started to be heated by a mantle heater at a stirring rotation speed of 810 rpm, and the growth of an aggregate particle is promoted at 54° C. At this time, the pH of the raw material dispersion is controlled to a range from 2.2 to 3.5 with 0.3 N nitric acid or an aqueous 1 N sodium hydroxide solution. The pH is maintained in the range above for about 2 hours to form a first aggregate particle.

Then, the temperature is raised to 56° C., and the particle diameter and shape of the first aggregate particle are regulated while checking the size and shape of the particle by means of an optical microscope and MULTISIZER II. The pH is elevated to 8.0 so as to fuse first aggregate particles and thereafter, the temperature is raised to 75° C. After confirming by an optical microscope that first aggregate particles are fused, the pH is lowered to 6.0 while keeping the temperature at 75° C. and after 1 hour, heating is stopped, followed by cooling at a temperature drop rate of 1.0° C./min.

In this way, a fused particle is obtained.

Subsequently, 66.7 parts of Resin Particle Dispersion (1) and 0.25 parts of an aqueous 10% nitric acid solution of polyaluminum chloride as an aggregating agent are additionally added. The resulting solution is started to be heated by a mantle heater while adjusting the stirring rotation speed to keep the liquid level always moving, and the growth of the aggregate particle is promoted at 54° C. At this time, the pH of the raw material dispersion liquid is controlled to a range from 2.2 to 3.5 with 0.3 N nitric acid or an aqueous 1 N sodium hydroxide solution. The pH is maintained in the range above for about 2 hours to form a second aggregate particle aggregated such that a resin particle is attached to the surface of a fused particle.

The temperature is raised to 56° C., and the aggregate particles are regulated while checking the size and morphology of the particle by means of an optical microscope and MULTISIZER II.

The pH is then elevated to 8.0 so as to fuse second aggregate particles and thereafter, the temperature is raised to 75° C. After confirming by an optical microscope that second aggregate particles are fused, the pH is lowered to 6.0 while keeping the temperature at 75° C. and after 1 hour, heating is stopped, followed by cooling at a temperature drop rate of 1.0° C./min. Thereafter, the particles are sieved through a 20 μm mesh, repeatedly washed with water and dried in a vacuum drier to obtain Comparative Toner Particle (C2). The volume average particle diameter of Comparative Toner Particle (C2) obtained is 14.6 μm. In addition, it is confirmed that Comparative Toner Particle (C2) is flat-shaped and the average equivalent-circle diameter D thereof is longer than the average maximum thickness C.

### <Evaluation Test>

### (Various Measurements)

With respect to the toners (toner particles thereof) produced in Examples and Comparative Examples, the number of brilliant pigments and the angle θ formed by mutual orientation directions of a plurality of brilliant pigments are measured according to the methods described above.

In addition, with respect to toners (toner particles thereof) produced in Examples and Comparative Examples, whether the binder resin intervenes in a gap between at least a pair of adjacent brilliant pigments out of a plurality of brilliant pigments is confirmed according to the method described above.

### (Cross-Sectional Observation)

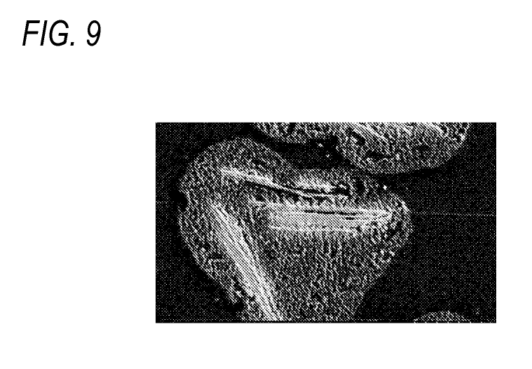

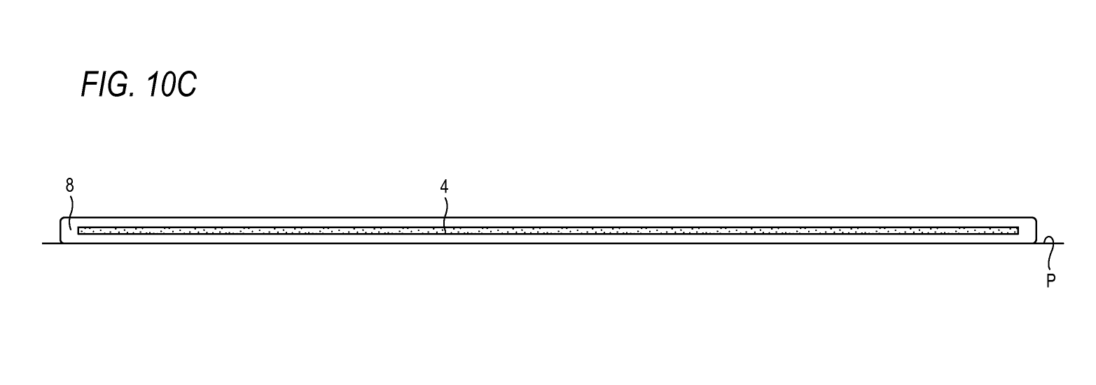

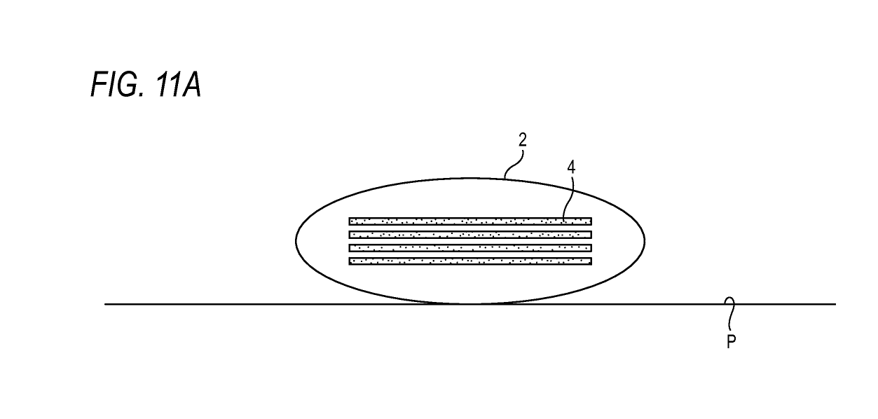

The cross-section of the toner (toner particle thereof) produced in each of Examples 1 to 10 and Comparative Examples 1 and 2 is observed by SEM. FIG. 5 shows a cross-sectional photograph of the toner (toner particle thereof) produced in Example 1. FIGS. 8 and 9 show cross-sectional photographs of the toners (toner particles thereof) produced in Comparative Examples 1 and 2, respectively.

As shown in FIG. 5, in the toner (toner particle thereof) produced in Example 1, it is observed that 5.5 brilliant pigments oriented mutually in the same direction are contained in one toner particle.

As shown in FIG. 8, in the toner (toner particle thereof) produced in Comparative Example 1, it is observed that 2.4 brilliant pigments are contained in one toner particle.

As shown in FIG. 9, in the toner (toner particle thereof) produced in Comparative Example 2, it is observed that 5.5 brilliant pigments are contained in one toner particle and the brilliant pigments are oriented in different directions.

### (Formation of Solid Image)

A solid image is formed by the following method.

First, paper of OK TOPCOAT PAPER (basis weight: 127, produced by Oji Paper Co., Ltd.) is set in APEOSPORT-V C5575, and an image of Cyan 61%, Magenta 18% and Yellow 12% with a total toner loading amount of 3.5 g/m² is output on the entire surface to produce paper colored with watery color (hereinafter, referred to as watery color paper).

Subsequently, a developer bottle of “COLOR 800 PRESS, modified machine” manufactured by Fuji Xerox Co., Ltd. is filled with the developer obtained in each of Examples and Comparative Examples, and a solid image with a brilliant toner loading amount of 4.5 g/m² is formed on watery color paper at a fixing temperature of 165° C. The “solid image” above indicates an image having a printing ratio of 100%.

### (Brilliance: Measurement of Ratio (X/Y) [FI Value])

With respect to the image area of the solid image formed, using a goniospectrocolorimeter GC5000L manufactured by Nippon Denshoku Industries Co., Ltd., incident light at an incident angle of −45° is made incident on the solid image and the reflectance X at a light-receiving angle of +30° and the reflectance Y at a light-receiving angle of −30° are measured. Here, each of the reflectance X and the reflectance Y is measured with light having a wavelength of from 400 nm to 700 nm at intervals of 20 nm, and the average value of reflectance at respective wavelengths is employed. The ratio (X/Y) [FI value] is calculated from these measurement results. The results are shown in Table 1.

A higher FI value indicates higher brilliant feeling, and when the FI value is 6 or more, a large majority of observers can experience metallic feeling. If the FI value is less than 6, the feel of dullness is strong, and brilliant feeling can be hardly experienced.

### (Color Shift: Color Difference ΔE)

With respect to the image area of the solid image formed, the chromaticity in the CIE1976 (L_{α}*,a_{α}*,b_{α}*) colorimetric system is measured using a reflection densitometer X-RITE 939 (manufactured by X-rite).

Likewise, with respect to the image area of a solid image formed in the same manner as above except for using a white recording medium (fresh OK TOPCOAT PAPER, basis weight: 127, produced by Oji Paper Co., Ltd.), the chromaticity in the CIE1976 (L*a*b*) colorimetric system is measured using a reflection densitometer X-RITE 939 (manufactured by X-rite).

Then, both solid images are measured for the chromaticity in the CIE1976 (L_{β}*,a_{β}*,b_{β}*) colorimetric system, and the color difference ΔE is determined from the values of both solid images. The calculation method of ΔE is shown below.

ΔE=[(L_{α}−L_{β})²+(a_{α}−a_{β})²+(b_{α}−b_{β})²]^{1/2}

As ΔE is lower, the color difference is smaller. Evaluation is performed according to the following criteria.

A: ΔE is 6.5 or less; a level where the colors appear the same and can be treated as an identical color.

B: ΔE is more than 6.6 and 13.0 or less; a level where the color difference corresponds to one rate in the JIS standard color chart, the Munsell color chart, etc. and the colors are perceived as the same color also on a sensory level in practical use.

C: ΔE is 13 or more; a level where the color difference is as large as allowing discrimination of different colors when compared with systematic color names and the colors are highly likely to be recognized as different colors also on a sensory level.

### (Image Unevenness)

A solid image formed on a white recording medium is observed with an eye and a 10-power magnifier, and the presence or absence of image unevenness is confirmed

A: Unevenness is rarely seen throughout the image in both the observation with an eye and the observation with a magnifier.

B: Unevenness is confirmed in a part of the image when observed with a magnifier, but can hardly be confirmed with an eye.

C: Unevenness present in a part of the image can be confirmed even with an eye but is a practically problem-free level.

D: Conspicuous unevenness can be confirmed in a part with an eye or unevenness can be confirmed throughout the surface with an eye, and this is a practically unsuitable level.

TABLE 1

| | | Number of | | | | | |
|---|---|---|---|---|---|---|---|
| | | Brilliant | | Presence or Absence of | Evaluation | | |
| | | Pigments | Angle θ Formed by Mutual | Binder Resin Intervening | Brilliance | Color | |
| | | in One | Orientation Directions of a | in Gap Between Brilliant | Ratio (X/Y) | Difference ΔE: | Image |
| | Developer | Toner particle | Plurality of Brilliant Pigments | Pigments | [FI value] | Judgment | Unevenness |
| Example 1 | Developer 1 | 5.5 | 9° | present | 8.4 | 5.8: A | A |
| Example 2 | Developer 2 | 3.7 | 3° | present | 7.4 | 6.1: A | A |
| Example 3 | Developer 3 | 8.6 | 10° | present | 8.2 | 6.4: A | B |
| Example 4 | Developer 4 | 16.1 | 13° | present | 7.8 | 9.2: B | C |
| Example 5 | Developer 5 | 4.9 | 15° | present | 7.5 | 11.5: B | A |
| Example 6 | Developer 6 | 7.8 | 18° | present | 7.2 | 10.3: B | A |
| Example 7 | Developer 7 | 7.3 | 5° | present | 8.3 | 5.3: A | A |
| Example 8 | Developer 8 | 4.7 | 2° | none | 7.1 | 7.4: B | A |
| Example 9 | Developer 9 | 5.1 | 5° | present | 8.1 | 6.3: A | A |
| Example 10 | Developer 10 | 9.1 | 22° | present | 8.2 | 12.4: B | C |
| Comparative | Developer C1 | 2.4 | 10° | present | 6.9 | 18.7: C | A |
| Example 1 | | | | | | | |
| Comparative | Developer C2 | 5.5 | 56° | present | 5.8 | 21.2: C | A |
| Example 2 | | | | | | | |

The results above reveal that in Examples of the present invention, good results are obtained in both evaluations of brilliance and color shift, compared with Comparative Examples.

It is understood from these results that in Examples of the present invention, when a brilliant image is formed on a recording medium colored with a color except for white and black, the brilliant image is kept from taking on a color tinge of the recording medium while suppressing reduction in the brilliance of the brilliant image and in addition, image quality deterioration such as image unevenness is also suppressed.

### <Preparation of Amorphous Resin Particle Dispersion (1)>

### (Preparation of Amorphous Resin Particle Dispersion (1))

| | | |
|---|---|---|
| Dimethyl adipate | 30 | parts |
| Dimethyl terephthalate | 221 | parts |
| Bisphenol A ethylene oxide adduct | 85 | parts |
| Bisphenol A propylene oxide adduct | 106 | parts |
| Ethylene glycol | 41 | parts |
| Tetrabutoxy titanate (catalyst) | 0.042 | parts |

These components are put in a heated and dried two-necked flask and subjected to temperature elevation under stirring while keeping an inert atmosphere by introducing nitrogen gas into the vessel and then to a co-condensation polymerization reaction at 160° C. for 7 hours. Thereafter, the temperature is raised to 220° C. while gradually reducing the pressure to 10 Torr and held for 3 hours. The pressure is once returned to an ordinary pressure, and 21 parts of trimellitic anhydride is added. The pressure is again gradually reduced to 10 Torr, and the reaction solution is held at 220° C. for 1 hour to synthesize Amorphous Polyester Resin (1).

The glass transition temperature (Tg) of Amorphous Polyester Resin (1) is determined by measuring the resin in conformity with ASTM D3418-8 by using a differential scanning calorimeter (DSC-50 manufactured by Shimadzu Corporation) under the condition of a temperature rise rate of 10° C./min from room temperature (25° C.) to 150° C. The glass transition temperature is defined as a temperature at the intersection between extended lines of a base line and a rising line in an endothermic portion. The glass transition temperature of Amorphous Polyester Resin (1) is 59.8° C., the mass average molecular weight Mw as measured by GPC is 52,000, and the number average molecular weight Mn is 6,500.

| | |
|---|---|
| Amorphous Polyester Resin (1) | 200 parts |
| Ethyl acetate | 340 parts |
| Aqueous sodium hydroxide solution (0.3M) | 5.5 parts |

These components are put in a 2,000-ml separable flask, heated at 70° C. and stirred with Three-One Motor (manufactured by Shinto Scientific Co., Ltd.) to prepare a resin mixed solution. While further stirring the resin mixed solution at 90 rpm, 550 parts of ion-exchanged water is gradually added to cause phase inversion emulsification, and the solvent is then removed to obtain Amorphous Resin Particle Dispersion (1) (solid content concentration: 25%). The volume average particle diameter of the resin particle in Amorphous Resin Particle Dispersion (1) is 182 nm.

### <Preparation of Amorphous Resin Particle Dispersion (2)>

| | |
|---|---|
| Styrene | 320 parts |
| n-Butyl acrylate | 120 parts |
| Acrylic acid | 3 parts |
| Dodecanethiol | 8 parts |
| Anionic surfactant (DOWFAX, produced by The | 12 parts |
| Dow Chemical Company) | |
| Ion-exchanged water | 950 parts |

Out of the components above, styrene, n-butyl acrylate, acrylic acid and dodecanethiol are mixed to prepare a solution, and this solution is dispersed/emulsified in a flask containing the anionic surfactant and ion-exchanged water (Monomer Emulsion 1). 2 Parts of the anionic surfactant is dissolved in 350 parts of ion-exchanged water, and the resulting solution is charged into a polymerization flask. The polymerization flask is tightly plugged, and a reflux tube is provided. The polymerization flask is then heated to 75° C. on a water bath under stirring while purging the inside of the polymerization flask with nitrogen and held for 45 minutes, and after a solution obtained by dissolving 7 parts of ammonium persulfate in 60 parts of ion-exchanged water is added dropwise to the polymerization flask over 12 minutes by means of a tube pump, Monomer Emulsion 1 is added dropwise over 60 minutes by means of a tube pump. Thereafter, the reaction solution is stirred for 4 hours while keeping the polymerization flask at 85° C., and the polymerization flask is cooled with ice water to 30° C. to complete the polymerization, whereby Amorphous Resin Particle Dispersion (2) (solid content concentration: 34%) is obtained. The mass average molecular weight Mw as measured by GPC is 31,000, the number average molecular weight Mn is 4,200, and the volume average particle diameter of the resin particle in Amorphous Resin Particle Dispersion (2) is 205 nm.

### <Preparation of Amorphous Resin Particle Dispersion (3)>

| | |
|---|---|
| Dimethyl adipate | 15 parts |
| Dimethyl terephthalate | 251 parts |
| Bisphenol A ethylene oxide adduct | 62 parts |
| Bisphenol A propylene oxide adduct | 126 parts |
| Ethylene glycol | 38 parts |
| Tetrabutoxy titanate (catalyst) | 0.040 parts |

These components are put in a heated and dried two-necked flask and subjected to temperature elevation under stirring while keeping an inert atmosphere by introducing nitrogen gas into the vessel and then to a co-condensation polymerization reaction at 160° C. for 7 hours. Thereafter, the temperature is raised to 220° C. while gradually reducing the pressure to 10 Torr and held for 3 hours. The pressure is once returned to an ordinary pressure, and 31 parts of trimellitic anhydride is added. The pressure is again gradually reduced to 10 Torr, and the reaction solution is held at 220° C. for 1 hour to synthesize Amorphous Polyester Resin (2).

The glass transition temperature (Tg) of Amorphous Polyester Resin (2) is determined by measuring the resin in conformity with ASTM D3418-8 by using a differential scanning calorimeter (DSC-50 manufactured by Shimadzu Corporation) under the condition of a temperature rise rate of 10° C./min from room temperature (25° C.) to 150° C. The glass transition temperature is defined as a temperature at the intersection between extended lines of a base line and a rising line in an endothermic portion. The glass transition temperature of Amorphous Polyester Resin (2) is 53.4° C., the mass average molecular weight Mw as measured by GPC is 42,000, and the number average molecular weight Mn is 7,600.

| | |
|---|---|
| Amorphous Polyester Resin (2) | 200 parts |
| Ethyl acetate | 340 parts |
| Aqueous sodium hydroxide solution (0.3M) | 5.5 parts |

These components are put in a 2,000-ml separable flask, heated at 70° C. and stirred with Three-One Motor (manufactured by Shinto Scientific Co., Ltd.) to prepare a resin mixed solution. While further stirring the resin mixed solution at 90 rpm, 550 parts of ion-exchanged water is gradually added to cause phase inversion emulsification, and the solvent is then removed to obtain Amorphous Resin Particle Dispersion (3) (solid content concentration: 28%). The volume average particle diameter of the resin particle in Amorphous Resin Particle Dispersion (3) is 175 nm.

### <Preparation of Brilliant Pigment Dispersion>

### (Preparation of Brilliant Pigment Dispersion (1A))

| | |
|---|---|
| Aluminum pigment (2173EA, produced by Showa | 100 parts |
| Alumi Company Limited) | |
| Anionic surfactant (BN2060, produced by Tayca | 1.5 parts |
| Corporation) | |
| Ion-exchanged water | 900 parts |

After removing the solvent from the paste of aluminum pigment, these components are mixed, dissolved, and dispersed for about 1 hour by using an emulsification dispersing machine CAVITRON (CR1010, manufactured by Pacific Machinery & Engineering Co., Ltd.) to prepare a brilliant pigment dispersion having dispersed therein a brilliant pigment (aluminum pigment) (solid content concentration: 10%).

### <Preparation of Crystalline Substance Particle Dispersion>

### (Preparation of Release Agent Dispersion)

### —Preparation of Release Agent Dispersion (1A)—

| | |
|---|---|
| Hydrocarbon-based wax (FNP0080, produced by | 270 parts |
| Nippon Seiro Co., Ltd., melting temperature: 80° C.) | |
| Anionic surfactant (BN2060, produced by Tayca | 12 parts |
| Corporation) | |
| Ion-exchanged water | 21.6 parts |

These components are mixed and after dissolving the release agent at an internal liquid temperature of 120° C. by using a pressure discharge homogenizer (manufactured by Gaulin, Inc., Gaulin Homogenizer), the mixture is subjected to a dispersion treatment at a dispersion pressure of 5 MPa for 120 minutes and then at 40 MPa for 360 minutes and cooled to obtain Release Agent Dispersion (1A). The volume average particle diameter D50 of the release agent in this release agent dispersion is 225 nm. Thereafter, the solid content concentration is adjusted to 20.0% with ion-exchanged water.

### —Preparation of Release Agent Dispersion (2A)—

| | |
|---|---|
| Ester-based wax (WEP-8, produced by NOF | 270 parts |
| Corporation, melting temperature: 79° C.) | |
| Anionic surfactant (BN2060, produced by Tayca | 12 parts |
| Corporation) | |
| Ion-exchanged water | 21.6 parts |

These components are mixed and after dissolving the release agent at an internal liquid temperature of 120° C. by using a pressure discharge homogenizer (manufactured by Gaulin, Inc., Gaulin Homogenizer), the mixture is subjected to a dispersion treatment at a dispersion pressure of 5 MPa for 120 minutes and then at 40 MPa for 360 minutes and cooled to obtain Release Agent Dispersion (2A). The volume average particle diameter D50 of the release agent in this release agent dispersion is 231 nm. Thereafter, the solid content concentration is adjusted to 20.0% with ion-exchanged water.

### (Preparation of Crystalline Resin Particle Dispersion)

### —Preparation of Crystalline Resin Particle Dispersion (1)—

| | |
|---|---|
| Sebacic acid | 102 parts |
| 1,9-Nonanediol | 85 parts |

The monomer components above are put in a reaction vessel equipped with a stirrer, a thermometer, a condenser and a nitrogen gas-introducing tube and after purging the inside of the reaction vessel with dry nitrogen gas, 0.47 parts of titanium tetrabutoxide (reagent) is charged thereinto. The reaction is allowed to proceed under stirring at 170° C. for 3 hours in a nitrogen gas stream and thereafter, the temperature is further raised to 210° C. over 1 hour. The pressure inside the reaction vessel is reduced to 3 kPa, and the reaction is performed with stirring for 13 hours under reduced pressure to obtain Crystalline Polyester Resin (1).

Crystalline Polyester Resin (1) obtained has a melting temperature by DSC of 71.2° C., a mass average molecular weight Mw by GPC of 25,000, and a number average molecular weight Mn of 10,500.

| | |
|---|---|
| Crystalline Polyester Resin (1) | 200 parts |
| Ethyl acetate | 520 parts |
| Aqueous sodium hydroxide solution (0.3M) | 3.2 parts |

These components are put in a 2,000-ml separable flask, heated at 75° C. and stirred with Three-One Motor (manufactured by Shinto Scientific Co., Ltd.) to prepare a resin mixed solution. While further stirring the resin mixed solution at 90 rpm, 450 parts of ion-exchanged water is gradually added to cause phase inversion emulsification, and the solvent is then removed to obtain Crystalline Resin Particle Dispersion (1) (solid content concentration: 28%). The volume average particle diameter of the resin particle in Crystalline Resin Particle Dispersion (1) is 175 nm.

### Example 1A

| | |
|---|---|
| Release Agent Dispersion (1A) | 80 parts |
| Brilliant Pigment Dispersion (1A) | 380 parts |
| Anionic surfactant (BN2060, produced by Tayca | 3 parts |
| Corporation) | |

The raw materials above are put in a 3-L cylindrical stainless steel vessel and dispersed/mixed for 10 minutes while applying a shear force thereto at 4,000 rpm by means of a homogenizer (ULTRA-TURRAX T50, manufactured by IKA). Subsequently, 15 parts of an aqueous 10% nitric acid solution of polyaluminum chloride as an aggregating agent is gradually added dropwise thereto, and the resulting mixture is dispersed/mixed for 15 minutes by setting the rotation speed of the homogenizer to 5,000 rpm to obtain a raw material dispersion liquid.

The raw material dispersion is then transferred to a vessel equipped with a thermometer and a stirring device using a stirring blade with two paddles, started to be heated by a mantle heater at a stirring rotation speed to 350 rpm, and left to stand at 54° C. At this time, the pH of the raw material dispersion is controlled to a range from 2.2 to 3.5 with 0.3 M nitric acid or an aqueous 1 M sodium hydroxide solution. The dispersion is kept under the conditions above for about 2 hours to form a first aggregate particle.

Furthermore, 584 parts of Amorphous Resin Particle Dispersion (1) is additionally added to form a second aggregate particle. The temperature is further raised to 56° C., and the second aggregate particles are regulated while checking the size and morphology of the particle. Thereafter, the pH is elevated to 8.0, and the temperature is then raised to 87° C. After confirming by an optical microscope that aggregate particles are fused, the pH is lowered to 6.0 while keeping the temperature at 87° C., and after 1 hour, heating is stopped, followed by cooling at a temperature drop rate of 1.0° C./min. Subsequently, the particles are sieved through a 40 μm mesh, repeatedly washed with water and then dried in a vacuum drier to obtain Toner Particle (1A). The volume average particle diameter of the Toner Particle (1A) obtained is 11.0 μm. In addition, it is confirmed that the Toner Particle (1A) is flat-shaped and the average equivalent-circle diameter D thereof is longer than the average maximum thickness C.

### (Production of Toner)

2.0 Parts of hydrophobic silica (RY50, produced by Nippon Aerosil Co., Ltd.) is mixed with 100 parts of Toner Particle (1A) by using a HENSCEL mixer at a peripheral velocity of 30 m/sec for 3 minutes. Thereafter, the mixture is sieved through a vibration sieve having a mesh size of 45 μm to prepare a toner.

### (Production of Carrier)

| | | |
|---|---|---|
| Ferrite particle (volume average particle diameter: 35 μm) | 100 | parts |
| Toluene | 14 | parts |
| Methyl methacrylate-perfluorooetylethyl acrylate | 1.6 | parts |
| copolymer (critical surface tension: 24 dyn/cm) | | |
| Carbon black (trade name: VXC-72, produced by | 0.12 | parts |
| Cabot Corporation, volume resistivity: 100 Ωcm or | | |
| less) | | |
| Crosslinked melamine resin particle (average particle | 0.3 | parts |
| diameter: 0.3 μm, insoluble in toluene) | | |

First, carbon black diluted with toluene is added to the copolymer, and the resultant mixture is dispersed using a sand mill. Subsequently, respective components above except for the ferrite particle are dispersed therein for 10 minutes by using a stirrer to prepare a coat layer-forming solution. This coat layer-forming solution and the ferrite particle are put in a vacuum deaeration-type kneader and stirred for 30 minutes at a temperature of 60° C. Toluene is then removed by distillation under reduced pressure to form a resin coat layer, and a carrier is thereby obtained.

### (Production of Developer)

36 Parts of the toner obtained above and 414 parts of the carrier obtained above are put in a 2-L V-blender, stirred for 20 minutes and thereafter, sieved with a mesh size of 212 μm to produce a developer.

### Example 2A

Toner Particle (2A) is produced as follows. A developer is produced in the same manner as in Example 1A except for using Toner Particle (2A).

### (Production of Toner Particle (2A))

A toner particle is obtained by performing the same operation except that in the production of Toner Particle (1A), the amount of Brilliant Pigment Dispersion (1A) is changed to 520 parts and the amount of Amorphous Resin Particle Dispersion (1) is changed to 528 parts. The volume average particle diameter of the toner particle obtained is 10.8 μm. In addition, it is confirmed that the toner particle is flat-shaped and the average equivalent-circle diameter D thereof is longer than the average maximum thickness C.

### Example 3A

Toner Particle (3A) is produced as follows. A developer is produced in the same manner as in Example 1A except for using Toner Particle (3A).

### (Production of Toner Particle (3A))

A toner particle is obtained by performing the same operation except that in the production of Toner Particle (1A), the amount of Brilliant Pigment Dispersion (1A) is changed to 340 parts, Release Agent Dispersion (1A) is replaced by Release Agent Dispersion (2A), and the amount of Amorphous Resin Particle Dispersion (1) is changed to 600 parts. The volume average particle diameter of the toner particle obtained is 10.9 μm. In addition, it is confirmed that the toner particle is flat-shaped and the average equivalent-circle diameter D thereof is longer than the average maximum thickness C.

### Example 4A

Toner Particle (4A) is produced as follows. A developer is produced in the same manner as in Example 1A except for using Toner Particle (4A).

### (Production of Toner Particle (4A))

A toner particle is obtained by performing the same operation except that in the production of Toner Particle (1A), the amount of Brilliant Pigment Dispersion (1A) is changed to 360 parts and Amorphous Resin Particle Dispersion (1) is replaced by 435 parts of Amorphous Resin Particle Dispersion (2). The volume average particle diameter of the toner particle obtained is 11.0 μm. In addition, it is confirmed that the toner particle is flat-shaped and the average equivalent-circle diameter D thereof is longer than the average maximum thickness C.

### Example 5A

Toner Particle (5A) is produced as follows. A developer is produced in the same manner as in Example 1A except for using Toner Particle (5A).

### (Production of Toner Particle (5A))

Toner Particle (5A) is obtained by the same method as that for Toner Particle (1A) except that the following composition is used to form a first aggregate particle.

| | |
|---|---|
| Release Agent Dispersion (1) | 80 parts |
| Brilliant Pigment Dispersion (1) | 380 parts |
| Crystalline Resin Dispersion (1) | 50 parts |
| Anionic surfactant (BN2060, produced by Tayca | 3 parts |
| Corporation) | |

The volume average particle diameter of the toner particle obtained is 11.1 μm. In addition, it is confirmed that the toner particle is flat-shaped and the average equivalent-circle diameter D thereof is longer than the average maximum thickness C.

### Example 6A

Toner Particle (6A) is produced as follows. A developer is produced in the same manner as in Example 1A except for using Toner Particle (6A).

### (Production of Toner Particle (6A))

A toner particle is obtained by performing the same operation except that in the production of Toner Particle (5A), the amount of Brilliant Pigment Dispersion (IA) is changed to 360 parts, the amount of Release Agent Dispersion (1A) is changed to 90 parts, the amount of Crystalline Resin Dispersion (1) is changed to 35.7 parts, and the amount of Amorphous Resin Particle Dispersion (1) is changed to 544 parts. The volume average particle diameter of the toner particle obtained is 10.7 In addition, it is confirmed that the toner particle is flat-shaped and the average equivalent-circle diameter D thereof is longer than the average maximum thickness C.

### Example 7A

Toner Particle (7A) is produced as follows. A developer is produced in the same manner as in Example 1A except for using Toner Particle (7A).

### (Production of Toner Particle (7A))

A toner particle is obtained by performing the same operation except that in the production of Toner Particle (5A), the amount of Brilliant Pigment Dispersion (1A) is changed to 300 parts, the amount of Release Agent Dispersion (1A) is changed to 40 parts, the amount of Crystalline Resin Dispersion (1) is changed to 7.1 parts, and the amount of Amorphous Resin Particle Dispersion (1) is changed to 640 parts. The volume average particle diameter of the toner particle obtained is 10.9 μm. In addition, it is confirmed that the toner particle is flat-shaped and the average equivalent-circle diameter D thereof is longer than the average maximum thickness C.

### <Evaluation Test>

### (Various Measurements)

With respect to the toners (toner particles thereof) produced in Examples and Comparative Examples, the number of brilliant pigments and the angle θ formed by mutual orientation directions of a plurality of brilliant pigments are measured according to the methods described above.

In addition, with respect to toners (toner particles thereof) produced in Examples and Comparative Examples, whether the crystalline substance intervenes in a gap between at least a pair of adjacent brilliant pigments out of a plurality of brilliant pigments is confirmed according to the method described above. The amount of the crystalline substance intervening in a gap between adjacent flat-shaped brilliant pigments is determined (in the Table, denoted by “Amount of Intervention”).

### (Formation of Solid Image)

A solid image is formed by the following method.

A developer bottle of “APEOSPORT IV C3370 (an apparatus equipped with a fixing device of an electromagnetic induction heating system and set to a nip pressure of fixing device of 1.6 kg/cm², a nip time of 35 seconds and a fixing temperature of 150° C.)” manufactured by Fuji Xerox Co., Ltd. is filled with the developer obtained in each of Examples and Comparative Examples, and a solid image with a toner loading amount of 3.5 g/m² is formed on a white recording medium (OK TOPCOAT+PAPER, produced by Oji Paper Co., Ltd.). The “solid image” above indicates an image having a printing ratio of 100%.

### (Brilliance: Measurement of Ratio (X/Y) [FI Value])

With respect to the image area of the solid image formed, using a goniospectrocolorimeter GC5000L manufactured by Nippon Denshoku Industries Co., Ltd. as the goniophotometer, incident light at an incident angle of −45° is made incident on the solid image and the reflectance X at a light-receiving angle of +30° and the reflectance Y at a light-receiving angle of −30° are measured. Here, each of the reflectance X and the reflectance Y is measured with light having a wavelength of from 400 nm to 700 nm at intervals of 20 nm, and the average value of reflectance at respective wavelengths is employed. The ratio (X/Y) [FI value] is calculated from these measurement results. The results are shown in Table 2. A higher FI value indicates higher brilliant feeling, and when the FI value is 6 or more, a large majority of observers can experience metallic feeling. If the FI value is less than 6, the feel of dullness is strong, and brilliant feeling can be hardly experienced.

### (Thermal Storability)

The thermal storability of the developer obtained in each of Examples and Comparative Examples is evaluated as follows.

The toner obtained in each of Examples and Comparative Examples is left to stand in an environment of 50° C./50% RH for about 24 hours and then charged onto a 53 μm sieve of a toner powder tester in which sieves having a mesh size of 53 μm, 45 μm and 38 μm are tandemly arranged in this order from the top, and vibration is applied at a vibration width of 1 mm for 90 seconds. The weight of the toner on each sieve after vibration is measured, and 0.5, 0.3 and 0.1 are weighted and added to the weight on top to bottom sieves, respectively. A value obtained by dividing the resulting new value by the sample amount before measurement is expressed in percentage.

The results are shown in Table 2. When the value expressed in percentage is 35% or less, the toner can be used in practice without a problem and therefore, the thermal storability is rated “A” when 35% or less and rated “B” when 35% or more.

TABLE 2

| | Number of | | | | | | |
|---|---|---|---|---|---|---|---|
| | Brilliant | Angle θ Formed by Mutual | Presence or Absence of | Amount of Crystalline | Evaluation | | |
| | Pigments | Orientation Directions of a | Crystalline Substance | Substance Intervening in | Brilliance, | Thermal Storability | |
| | in One Toner | Plurality of Brilliant | Intervening in Gap Between | Gap Between Brilliant | Ratio (X/Y) | Percentage | |
| | Particle | Pigments | Brilliant Pigments | Pigments (μm²) | [FI Value] | (%) | Judgment |
| Example 1A | 5 | 6.8 | present | 1.3 | 8.1 | 21 | A |
| Example 2A | 9 | 9.4 | present | 2.2 | 8.0 | 25 | A |
| Example 3A | 6 | 9.7 | present | 1.4 | 7.2 | 27 | A |
| Example 4A | 5 | 7.9 | present | 1.5 | 6.8 | 20 | A |
| Example 5A | 6 | 7.6 | present | 0.9 | 7.1 | 14 | A |
| Example 6A | 5 | 6.8 | present | 2.1 | 6.7 | 30 | A |
| Example 7A | 7 | 8.4 | present | 0.2 | 6.5 | 11 | A |

The results above reveal that in Examples of the present invention, good results are obtained in the evaluation of brilliance.

It is also understood that in Examples of the present invention, good results are obtained also in the evaluation of thermal storability.

What is claimed is:

1. A brilliant toner comprising a toner particle containing:
a binder resin, and
flat-shaped brilliant pigments,
wherein the number of the brilliant pigment contained is from 3.5 to 15 and the plurality of brilliant pigments are oriented mutually in the same direction.

2. The brilliant toner as claimed in claim 1,
wherein at the time of formation of a solid image, the brilliant toner satisfies the following formula:
2≦X/Y≦100
wherein X represents the reflectance at a light-receiving angle of +30° and Y represents the reflectance at a light-receiving angle of −30°, which are measured when irradiating the image with incident light at an incident angle of −45° by means of a goniophotometer.

3. The brilliant toner as claimed in claim 1,
wherein the number of the brilliant pigment is from 4 to 8.

4. The brilliant toner as claimed in claim 1,
wherein a resin or a crystalline substance intervenes in a gap between at least a pair of brilliant pigments adjacent to each other, out of the plurality of brilliant pigments.

5. The brilliant toner as claimed in claim 1,
wherein a volume average particle diameter of the toner particles containing the brilliant pigment is from 3 μm to 30 μm.

6. The brilliant toner as claimed in claim 4,
wherein the crystalline substance is a hydrocarbon-based wax.

7. The brilliant toner as claimed in claim 1,
wherein the binder resin contains an amorphous polyester.

8. The brilliant toner as claimed in claim 1,
wherein the average length in a long axis direction of the brilliant pigments is from 1 μm to 30 μm.

9. The brilliant toner as claimed in claim 1,
wherein in the toner particles, a ratio (C/D) between the average maximum thickness C of the toner particles and an average equivalent-circle diameter D of the toner particles is from 0.001 to 0.200.

10. An electrostatic image developer containing the brilliant toner claimed in claim 1 and a carrier.

11. The electrostatic image developer as claimed in claim 10,
wherein at the time of formation of a solid image, the brilliant toner satisfies the following formula:
2≦X/Y≦100
wherein X represents the reflectance at a light-receiving angle of +30° and Y represents the reflectance at a light-receiving angle of −30°, which are measured when irradiating the image with incident light at an incident angle of −45° by means of a goniophotometer.

12. The electrostatic image developer as claimed in claim 10,
wherein in the brilliant toner, the number of the brilliant pigment contained is from 4 to 8.

13. The electrostatic image developer as claimed in claim 10,
wherein in the brilliant toner, a resin or a crystalline substance intervenes in a gap between at least a pair of brilliant pigments adjacent to each other, out of the plurality of brilliant pigments.

14. A toner cartridge comprising a container storing the brilliant toner claimed in claim 1, which is able to be attached to and detached from an image forming apparatus.

15. The toner cartridge as claimed in claim 14,
wherein in the brilliant toner, the number of the brilliant pigment contained is from 4 to 8.

16. The toner cartridge as claimed in claim 14,
wherein in the brilliant toner, a resin or a crystalline substance intervenes in a gap between at least a pair of brilliant pigments adjacent to each other, out of the plurality of brilliant pigments.
